(19) United States
(12) Patent Application Publication
(10) Pub. No.: US 2022/0358501 A1
(43) Pub. Date: Nov. 10, 2022

(54) COMPUTING SYSTEM FOR SHARING NETWORKS PROVIDING PAYMENT ALLOCATION BASED UPON DISTRIBUTED RESERVING AND RELATED METHODS

(71) Applicant: SHARABLE, LLC, Melbourne, FL (US)

(72) Inventor: ANTHONY F. MEGGS, MELBOURNE, FL (US)

(21) Appl. No.: 17/814,264

(22) Filed: Jul. 22, 2022

Related U.S. Application Data
(63) Continuation-in-part of application No. 16/918,727, filed on Jul. 1, 2020, now abandoned.
Application No. 16/918,727 is a continuation-in-part of application No. 16/876,736, filed on May 18, 2020.
(60) Provisional application No. 62/851,282, filed on May 22, 2019.
(60) Provisional application No. 62/851,279, filed on May 22, 2019.
(60) Provisional application No. 62/851,298, filed on May 22, 2019.
(60) Provisional application No. 62/851,395, filed on May 22, 2019.
(60) Provisional application No. 62/851,321, filed on May 22, 2019.
(60) Provisional application No. 62/869,661, filed on Jul. 2, 2019.

(51) Int. Cl. G06Q 20/40; G06Q 20/38; G06Q 40/00

(52) U.S. Cl. CPC G06Q 20/405; G06Q 20/389; G06Q 40/12; G06Q 20/401

(57) ABSTRACT

A method may include, at a computing device, operating a virtual share exchange (VSE) platform in which recurring electronic deposits to member sharing accounts include a share portion and a dynamic reserve portion to respectively accumulate sharing funds and reserve funds in the member sharing accounts. A single purpose table may be dynamically generating in real time on the VSE platform for a given member healthcare bill that defines a temporary virtual bill account solely for reconciliation of the respective member healthcare bill, with the temporary virtual bill account being externally addressable through a routing number and a unique account number. The virtual bill account may provide an auditable ledger for the transactions in the temporary virtual bill account. Furthermore, the dynamic reserve portion may be adjusted to change the recurring electronic deposits to bring an aggregate amount of reserve balance funds back into a reserve balance target range.

### CROSS-REFERENCE TO RELATED APPLICATIONS

This application is a continuation-in-part of U.S. App. No. 16,918,727 filed Jul. 1, 2020, which is a continuation-in-part of U.S. application Ser. No. 16/876,736 filed May 18, 2020, which claims the benefit of provisional application nos. 62/851,282; 62/851,279; 62/851,298; 62/851,395; 62/851,321 filed May 22, 2019, and provisional application No. 62/869,661 filed Jul. 2, 2019, all of which are hereby incorporated herein in their entireties by reference.

### TECHNICAL FIELD

The present invention relates generally to computing systems and, more particularly, to computer infrastructures that provide for implementation of Virtual Share Exchange (VSE) platforms.

### BACKGROUND

In recent years, health care expense sharing has emerged as a “decentralized” approach to financing and reserving for health care costs. As a “non-insurance” alternative, health care sharing is not subject to typical insurance regulations. Individual participants are legally and ultimately responsible for their own medical bills. However, participants in health care sharing networks willingly and consistently share from their own personal funds to pay each other's medical bills.

Some health care sharing networks implement a technology framework often called a Virtual Share Exchange (VSE). The VSE may include a collection of virtual account management, billing, and payment technologies that form a comprehensive and transparent health care sharing process. The VSE model enables health care sharing networks to facilitate sharing programs on a P2P (or member-to-member) basis to help provide compliance with applicable safe harbor exemptions to insurance regulations.

VSE platforms have enabled healthcare sharing networks to rapidly grow and scale similar to institutional computer network models, like health insurance. Modern VSE platforms have become advanced Fintech applications that integrate all the stakeholders and financial processes that are necessary to facilitate member-to-member sharing via computer networking and electronic payment infrastructure.

### SUMMARY

A computing device may include a memory and a processor configured to cooperate with the memory to operate a virtual share exchange (VSE) platform by establishing member sharing accounts on the VSE platform for respective members of the VSE platform for receiving recurring electronic deposits from the respective members from external payment sources to be used for sharing payment of member healthcare bills across a plurality of the member sharing accounts. The member sharing accounts may have unique identifiers (IDs), and the recurring electronic deposits may include a share portion and a dynamic reserve portion to respectively accumulate sharing funds and reserve funds in the member sharing accounts. Healthcare provider accounts may be established on the VSE platform for healthcare providers issuing member healthcare bills, a given member healthcare bill may be received that is issued by a given healthcare provider, and payment amounts of the given member healthcare bill may be matched and allocated to sharing funds in member sharing accounts on a member-to-member basis based upon member agreement to share in payment of the given member healthcare bill. A single purpose table may be dynamically generated in real time in a database on the VSE platform for the given member healthcare bill submitted for payment sharing corresponding to the given healthcare provider, with the single purpose table defining a temporary virtual bill account solely for reconciliation of the respective member healthcare bill, and the temporary virtual bill account being externally addressable through a routing number and a unique account number. The single purpose table may link the given member healthcare bill to the unique IDs of the member sharing accounts of members sharing in the given member healthcare bill so that transactions in the temporary virtual bill account are viewable to members sharing in the given member healthcare bill. Sharing funds may be electronically transferred from the member sharing accounts to the healthcare provider account for the given healthcare provider that issued the given member healthcare bill using the externally addressable routing number and unique account number of the temporary virtual bill account based upon the single purpose table and without transferring the funds between the member sharing accounts, and the virtual bill account may be closed and archived upon electronically transferring the funds to the healthcare provider account for the given healthcare provider that issued the member healthcare bill, with the archived virtual bill account providing an auditable ledger for the transactions in the temporary virtual bill account.

In an example embodiment, the processor may be further configured to calculate an aggregate amount of available reserve funds across the member sharing accounts as funds are electronically transferred for payment sharing of the member healthcare bills, compare the calculated aggregate amount of available reserve funds to a reserve target fund range, and adjust the dynamic reserve portion to change the recurring electronic deposits responsive to the calculated aggregate amount of reserve balance falling outside of the reserve balance target range to bring the aggregate amount of reserve balance funds back into the reserve balance target range.

In some embodiments, the reserve target fund range may comprise a real-time minimum aggregate amount of available reserve funds, and a real-time maximum aggregate amount of available reserve funds. In other embodiments, the reserve target fund range may comprise a forecasted minimum aggregate amount of available reserve funds, and a forecasted maximum aggregate amount of available reserve funds. By way of example, the forecasted minimum and maximum aggregate amounts of available reserve funds are based upon at least one of a number of net new members to the VSE, an aggregate amount of new funds per member, and net withdrawals per member, over a time period. In an example embodiment, adjusting may comprise changing the dynamic reserve portion of the electronic deposits further based upon a cost of living differential associated with respective different geographical locations of the members of the VSE.

The processor may be further configured to generate graphical user interfaces (GUIs) for viewing the transactions in the temporary virtual bill account. In addition, the processor may also be configured to receive pre-payment requests issued by the healthcare providers for funding prior to performing healthcare services, and to dynamically generate in real time single purpose tables defining temporary virtual bill accounts for payment sharing for the pre-payment requests.

A related method may include, at a computing device, operating a virtual share exchange (VSE) platform by establishing member sharing accounts on the VSE platform for respective members of the VSE platform for receiving recurring electronic deposits from the respective members from external payment sources to be used for sharing payment of member healthcare bills across a plurality of the member sharing accounts. The member sharing accounts may have unique identifiers (IDs), and the recurring electronic deposits including a share portion and a dynamic reserve portion to respectively accumulate sharing funds and reserve funds in the member sharing accounts. The method may include establishing healthcare provider accounts on the VSE platform for healthcare providers issuing member healthcare bills, receiving a given member healthcare bill issued by a given healthcare provider, and matching and allocating payment amounts of the given member healthcare bill to sharing funds in member sharing accounts on a member-to-member basis based upon member agreement to share in payment of the given member healthcare bill. The method may also include dynamically generating in real time a single purpose table in a database on the VSE platform for the given member healthcare bill submitted for payment sharing corresponding to the given healthcare provider, with the single purpose table defining a temporary virtual bill account solely for reconciliation of the respective member healthcare bill, and the temporary virtual bill account being externally addressable through a routing number and a unique account number. The single purpose table linking the given member healthcare bill to the unique IDs of the member sharing accounts of members sharing in the given member healthcare bill so that transactions in the temporary virtual bill account are viewable to members sharing in the given member healthcare bill. The method may further include electronically transferring sharing funds from the member sharing accounts to the healthcare provider account for the given healthcare provider that issued the given member healthcare bill using the externally addressable routing number and unique account number of the temporary virtual bill account based upon the single purpose table and without transferring the funds between the member sharing accounts, and closing and archiving the virtual bill account upon electronically transferring the funds to the healthcare provider account for the given healthcare provider that issued the member healthcare bill, with the archived virtual bill account providing an auditable ledger for the transactions in the temporary virtual bill account.

A related non-transitory computer-readable medium may computer-executable instructions for causing a computing device to perform steps including operating a virtual share exchange (VSE) platform by establishing member sharing accounts on the VSE platform for respective members of the VSE platform for receiving recurring electronic deposits from the respective members from external payment sources to be used for sharing payment of member healthcare bills across a plurality of the member sharing accounts, with the member sharing accounts having unique identifiers (IDs), and the recurring electronic deposits including a share portion and a dynamic reserve portion to respectively accumulate sharing funds and reserve funds in the member sharing accounts. The steps may further include establishing healthcare provider accounts on the VSE platform for healthcare providers issuing member healthcare bills, receiving a given member healthcare bill issued by a given healthcare provider, and matching and allocating payment amounts of the given member healthcare bill to sharing funds in member sharing accounts on a member-to-member basis based upon member agreement to share in payment of the given member healthcare bill. The steps may further include dynamically generating in real time a single purpose table in a database on the VSE platform for the given member healthcare bill submitted for payment sharing corresponding to the given healthcare provider, with the single purpose table defining a temporary virtual bill account solely for reconciliation of the respective member healthcare bill, and the temporary virtual bill account being externally addressable through a routing number and a unique account number. The single purpose table may link the given member healthcare bill to the unique IDs of the member sharing accounts of members sharing in the given member healthcare bill so that transactions in the temporary virtual bill account are viewable to members sharing in the given member healthcare bill. The steps may further include electronically transferring sharing funds from the member sharing accounts to the healthcare provider account for the given healthcare provider that issued the given member healthcare bill using the externally addressable routing number and unique account number of the temporary virtual bill account based upon the single purpose table and without transferring the funds between the member sharing accounts, and closing and archiving the virtual bill account upon electronically transferring the funds to the healthcare provider account for the given healthcare provider that issued the member healthcare bill, with the archived virtual bill account providing an auditable ledger for the transactions in the temporary virtual bill account.

### BRIEF DESCRIPTION OF THE DRAWINGS

FIG. 1 is a schematic block diagram of a computing device for implementing a virtual share exchange (VSE) computing platform in an example embodiment.

FIGS. 2 and 3 are display views of a graphical user interface (GUI) which may be generated by the computing device of FIG. 1 and providing individual household and overall community account information, respectively, for a VSE.

FIG. 4 is a flow diagram illustrating example method aspects associated with the system of FIG. 1.

FIG. 5 is a schematic block diagram illustrating an example implementation of the computing device of FIG. 1.

FIG. 6 is a flow diagram illustrating method aspects associated with the system of FIG. 5.

FIG. 7 is a sequence flow diagram illustrating example method aspects associated with the system of FIG. 1 in accordance with another embodiment.

FIG. 8 is a schematic block diagram of a computing device of the system of FIG. 1 which may be used to implement the VSE platform thereof in an example embodiment.

FIG. 9 is a ledger view of a virtual bill account which may be provided by the VSE platform of the system of FIG. 1 in an example embodiment for a member healthcare bill.

FIG. 10 is a ledger view of a virtual bill account which may be provided by the VSE platform of the system of FIG. 1 in an example embodiment for a pre-service escrow request.

FIG. 11 is a display view of a Graphical User Interface (GUI) generated by the computing device of FIG. 8 for a bill owner in accordance with an example embodiment.

FIG. 12 is a display view of the GUI of FIG. 11 with an overlaid pop-out GUI illustrating ledger details of a virtual bill account listed in the underlying bill owner account.

FIG. 13 is a display view of a GUI generated by the computing device of FIG. 8 for a bill contributor in accordance with an example embodiment.

FIG. 14 is a display view of the GUI of FIG. 13 with an overlaid pop-out GUI illustrating ledger details of a virtual bill account listed in the underlying bill contributor account.

FIG. 15 is a display view of the GUI generated by the computing device of FIG. 8 for a bill service provider in accordance with an example embodiment.

FIG. 16 is a schematic block diagram of another computing system providing payment sharing across a virtual share exchange (VSE) network platform with dynamic reserving in accordance with an example embodiment.

FIG. 17 is a table illustrating an example health care sharing dynamic reserve engine profile which may be used by the computing system of FIG. 16 in an example embodiment.

FIG. 18 is a table illustrating an example reserve summary which may be generated by the VSE monitoring service of the system of FIG. 16 in an example embodiment.

FIG. 19 is a table illustrating an example performance indicator summary which may be generated by the VSE monitoring service of the system of FIG. 16 in an example embodiment.

FIG. 20A is a table illustrating an example assignment analysis which may be generated by the dynamic reserve engine of the system of FIG. 16 in an example embodiment.

FIG. 20B is a flow diagram illustrating the steps of the example assignment analysis of FIG. 20A.

FIG. 21 is a display view of a graphical user interface (GUI) generated by the server of the system of FIG. 16 in an example embodiment providing a health care sharing statement including member sharing and dynamic reserve portions when an aggregate dynamic reserve is outside of a reserve target range.

FIG. 22 is a display view of the GUI of FIG. 21 providing a health care sharing statement when the aggregate dynamic reserve is within the reserve target range.

FIG. 23 is a schematic block diagram of a processor of the server of FIG. 16 and associated computing modules in an example embodiment.

FIG. 24 is a flow diagram illustrating example method aspects associated with the system of FIG. 16 in an example embodiment.

### BRIEF DESCRIPTION OF THE DRAWINGS

Example embodiments will now be described more fully hereinafter with reference to the accompanying drawings, in which the example embodiments are shown. The embodiments may, however, be implemented in many different forms and should not be construed as limited to the specific examples set forth herein. Rather, these embodiments are provided so that this disclosure will be thorough and complete. Like numbers refer to like elements throughout.

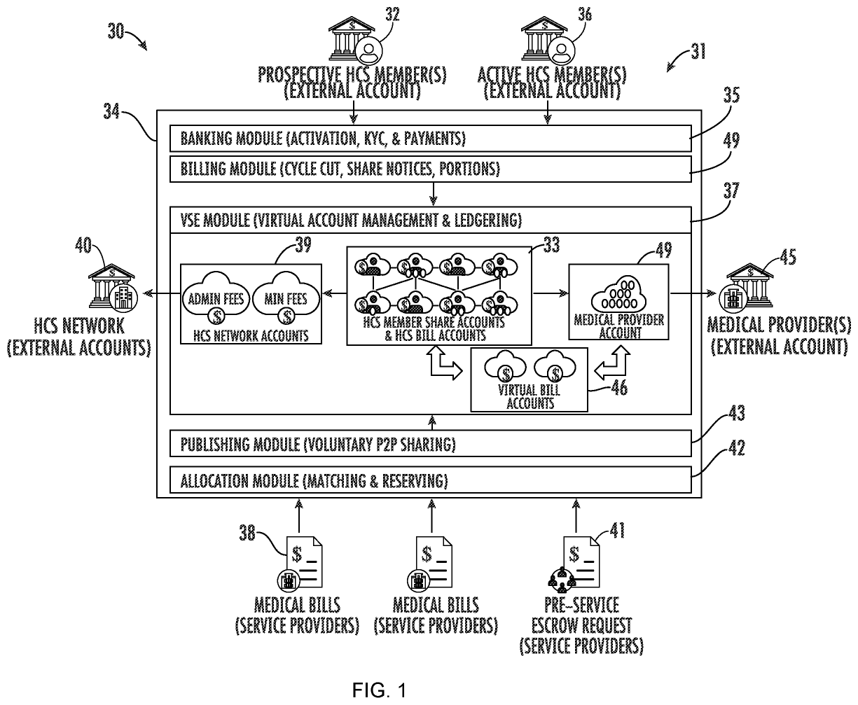

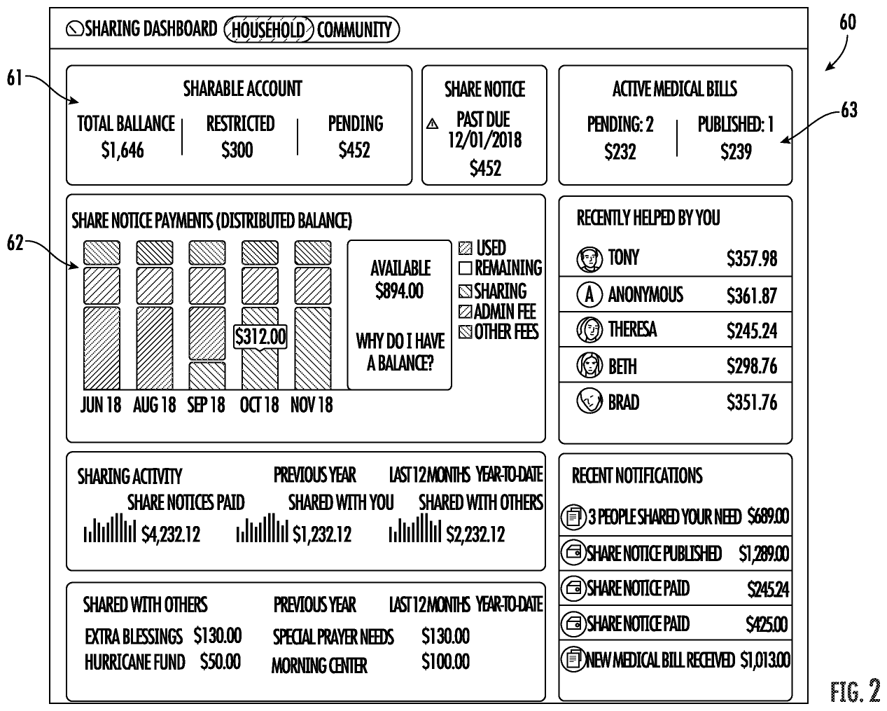

Referring initially to FIGS. 1-2, a VSE 30 implemented using a VSE platform 31 implemented via a computing device (e.g., server) 34 which provides for payment sharing within a virtual share exchange (VSE) platform 31 based upon similarities of member attributes is first described. By way of background, individuals joining forces as a group to achieve certain benefits and advantages is common in many facets of our everyday life. The power of groups is largely evident in the pooling practice found in the traditional insurance model. By pooling their resources through a centralized insurance company or common fund, groups are able to finance, reserve, and pay the expenses associated with the type of insurance risk. Without being able to rely on the insurance company and its practice of pooling funds, the individuals would be left to bear the cost and risk of a catastrophic loss by themselves.

Historically, traditional insurance companies were largely successful at helping groups of individuals finance and reserve for their expenses and catastrophic risk. By collecting and pooling both the risk and the resources of individuals into centralized group fund, traditional insurance coverage and the benefits obtained therefrom were made more affordable. In the past, the efficiency of pooling and reserving resources in a centralized fund enabled insurance companies to not only provide affordable coverage, but to capture a profit or bounty for pooling those resources into a central fund. Resources that are collected and pooled into the centralized fund are called “premiums”, which is derived from the Latin word “praemium” and defined as a “reward, profit or bounty for a specified act”. Thus, insurance companies were able to generate significant profit by extracting a “premium” from groups of individuals who were unable to pool resources to finance and reserve for their individual risk of catastrophic loss and costs.

Traditionally, the affordability of insurance coverage was predicated upon the overall wellness of the group and their consumption of services. For example, in healthcare, some members' need for medical services could be little more than annual checkups, while other individuals might need to access and consume services much more extensively. It is the latter group that has a greater effect on the overall costs of the group and the subsequent premiums collected. For those that do not frequently draw upon the centralized fund's resources, being lumped with the more extensive users is unfavorable. On the flip side, those who consume a larger share of the benefits may enjoy lower premiums because the individuals that consume little are subsidizing the expense of frequent consumers. In the past, insurance companies would respond to individuals who draw disproportionally on the centralized fund by raising their premiums to maintain group equity and ensure company profits.

With respect to financing and reserving for health care, the average consumer would not be able to afford much more than the very basic of health care services if the pooling of resources was not available through insurance. In fact, based upon current rates being charged by the medical industry, cutting edge or life-saving surgeries, drugs and treatments would be difficult, if not, impossible, for the average consumer to obtain.

However, in recent years the affordability and profitability of the traditional insurance model has been degraded by the enactment of government regulations. New laws and regulations have all but eliminated an insurance company's ability to segment groups of healthy individuals into centralized funds, or plans, that price premiums according to the group's health and draw on resources. Similarly, new regulations have mandated that all centralized funds, or plans, cover new and more extensive medical services not historically offered by health insurance companies. As a result, health insurance companies have been greatly limited in their ability to offer affordable coverage that is reflective of the health condition and medical usage of individual participants, as well offer affordable plans that provide access to the medical services that participants actually desire, versus services the government mandates.

Another disadvantage of the health insurance model and the associated regulations is that individuals of the centralized fund and plan can lead unhealthy or “at risk” lifestyles such as high-risk diets, low exercise, smoking, excessive alcohol intake and the use of illicit drugs, all without consequence. By engaging in such lifestyles, these individuals increase their likelihood of drawing on the resources and benefits of the centralized fund. The more these “high-risk” individuals are allowed to make choices and lead lives without consequences, the more likely that costs and premiums increase for everyone in the fund.

An additional disadvantage of the centralized insurance model is that the plan benefits are distributed to individuals of the group in such a way that no other individual participating in the plan has any real sense of what types of benefits or services are being paid for by the insurance company. The centralized insurance model provides no visibility into the size of the fund, the number of participating individuals, the size of available reserves, the flows of money, or profits pocketed by the insurance company. Thus, participating individuals are unaware of the financial health and wellness of the fund. This lack of transparency also makes individuals feel less responsible for their lifestyle choices that increase their draw of resources, as well as less connected and accountable to their fellow participants who are paying their bills.

The structural inefficiencies, inherent in the design of the centralized health insurance model, have been recently exposed by the new government mandates and regulations in health care. It has caused a rapid and unsustainable rise in premiums and insurance costs. Thus, the centralized health insurance model has become unaffordable and subsequently obsolete. And while the changes have been focused exclusively on healthcare, the aforementioned problems similarly persist in the other insurance markets.

As a result, consumers have sought out new and more innovative ways to organize themselves into groups that leverage the strength of their combined resources to finance and reserve for their health care costs. Unlike the centralized insurance model, consumers are turning to decentralized network models that are enabled by technologies that replace the pooling functions of traditional insurance companies.

In recent years, health care sharing has emerged as the most popular “decentralized” approach to financing and reserving for health care costs. As a “non-insurance” concept, health care sharing is not encumbered by insurance regulations. Individual participants are legally and ultimately responsible for their own medical bills. However, participants in health care sharing networks willingly and consistently share from their own personal funds to pay each other's medical bills. Health care sharing networks have been in existence since the early 1980s, but in recent years have grown to become a significant alternative to the centralized insurance model. Today, health care sharing networks enjoy safe harbor exemptions in U.S. health care laws and more than 30 states. Participants of health care sharing networks are sharing billions of dollars worth of medical bills on an annual basis. Free from insurance regulations, health care sharing networks can design and implement programs that are more efficient and affordable than insurance, as well as hold participants more accountable to each other.

As noted above, some health care sharing networks implement a technology framework often called a Virtual Share Exchange or VSE. The VSE platform 31 set forth herein may include a collection of computing hardware (e.g., servers or other computing devices including microprocessors and associated memory with non-transitory computer readable instructions) to implement virtual account management, billing, and payment modules that form a comprehensive and transparent health care sharing process. The VSE model enables health care sharing networks to facilitate sharing programs on a P2P (or member-to-member) basis to help ensure that these sharing networks refrain from the practice of insurance, and remain in compliance with the safe harbor exemptions of insurance rules/regulations.

Moreover, contemporary VSE platforms 31 have enabled healthcare sharing networks to rapidly grow and scale their networks by leveraging social trends towards the democratization of centralized institutional business models, like health insurance. Modern VSE platforms 31 have become advanced Fintech applications that integrate all the stakeholders and financial processes that facilitate member-to-member sharing.

Prospective members 32 are consumers who are applying for membership into the sharing network and its community. In order to complete their application for membership, prospective members 32 setup and activate their share account 33 through a computing device(s) 34, such as a server. In an example embodiment, the computing device 34 may be part of a cloud computing architecture, although other configurations may be used in different embodiments. Share or sharing accounts 33 are activated through a graphical user interface or GUI (often called the Application Center or Activation Center) to access account activation services within a banking module 35 of the computing device 34.

Active members 36 are consumers who have been accepted and are active in the sharing network and associated community. Active members 36 make monthly deposits (called monthly share amounts) electronically into their share account 33 that is held within a VSE/for the benefit of (FBO) module 37 of the computing device 34. To pay (or deposit) their monthly share amount into their share account 33, members 36 access services within the banking module 35 through a graphical user interface 60, as will be discussed further below. The banking module 35 provides services that enable members 36 to link their share account 33 to an external payment method and initiate recurring monthly transactions.

The banking module 35 may be implemented as a cloud-based application that enables both prospective members 32 and active members 36 to activate and manage their participation in the sharing network's program through a financial account (called a share account 33) that the member owns and controls. The banking module 35 enables members 36 to link an external bank account to their share account 33, to fund their share account per the terms of the sharing network, and to manage banking and regulatory compliance.

The billing module 49 may be implemented as a cloud-based application that calculates monthly share prices and creates the monthly share notices for the sharing network. Moreover, the billing module bills, publishes and collects the monthly share notice per the terms of the sharing network.

The VSE/FBO module 37 may also be implemented as a cloud based virtual account management and ledgering system that enables the sharing network to facilitate the member-to-member sharing and payment of member bills. The VSE/FBO module 37 enables member-to-member sharing through virtual accounts 33 that are owned and individually controlled by the members 36 and not the sharing network, as well as to house those virtual accounts in a single FBO account held by a financial institution “for the benefit of” the member 36.

The member share accounts 33 are member owned and controlled virtual accounts maintained by the VSE/FBO module 37, and are required for members 36 to participate in the sharing network. The share accounts 33 enable the sharing network to build distributed reserves in accounts that are owned and controlled by its members 36, and facilitate member-to-member sharing through those accounts.

Sharing network fee accounts 39 are virtual accounts maintained by the VSE/FBO module 37 that are owned and controlled by the sharing network and used to comply with any potential regulatory constraints. The fee accounts 39 help segregate “member owned” funds that are held in share accounts 33 and used for sharing from “network owned” funds, which are operating fees that are billed and collected as a part of a monthly share notice.

Sharing network external accounts 40 are external bank accounts that are owned and controlled by the sharing network and are linked to a specific sharing network fee account 39 that resides in the VSE/FBO module 37. As operating fees are collected through the payment by members 36 of monthly share notices, sharing networks are able to access those funds by transferring them out of the sharing network fee account 39 to its linked external account 40. The sharing network external accounts 40 allow for withdrawing operating funds out of the VSE/FBO module 37.

The member bills 38 are invoices billed by a member's service provider that have been received by the sharing network. The member bills 38 are to be shared by the members of the sharing network per the network's guidelines. In some instances, medical providers might also submit a pre-service escrow request 41 to request a pre-payment or escrow of funds before services are rendered, as will be discussed further below.

A sharing reserve request 41 represents a member bill from another sharing network that is participating in a federation or collaboration of sharing networks who have agreed to share in each other's member bills per the terms of a shared reserve agreement. Further details regarding sharing reserve requests are set forth in co-pending U.S. application Ser. No. 15/931,786 filed May 14, 2020, which is hereby incorporated herein in its entirety by reference.

An allocation module 42 may be implemented as a cloud-based bill matching and allocation service enabling sharing networks to facilitate bill sharing, help ensure regulatory compliance, and to generate more meaningful sharing transactions. The allocation module 42 may be used to match and allocate bills on a member-to-member basis, and to draw down distributed bills in a way that is equitable to all members 36.

A publishing module 43 may be implemented as a cloud-based notification and sharing service for initiating member-to-member (P2P) account transfers. The publishing module 43 notifies members 36 as to whose bill they have been matched to, and how much of their available share account 33 balance has been allocated as a contribution to the payment that member's bill, as well as to provide each matched member with the means to voluntarily share (agree) in the payment of that bill.

The provider account 44 is a virtual account within the VSE module 37 that is owned and managed by individual service providers, or a single virtual “settlement” account that aggregates funds for multiple payments made to multiple service providers, or some combination of both. The provider account(s) 44 segregate funds that have been shared and collected for the payment of a bill 38 or 41, and to make those funds available to the appropriate service provider.

An external provider account 45 is a linked external account owned and managed by an individual service provider for transferring funds out of the VSE/FBO module 37 or linked external account owned and managed by a payment processor for transferring multiple payments to be made to multiple service providers. More particularly, the provider external accounts 45 allow for withdrawing bill 38, 41 payments out of the VSE/FBO module 37.

In order to maintain a status as a non-insurance entity, many states oblige healthcare sharing networks to exclusively practice a member-to-member (or peer-to-peer) transfer of funds versus pooling or holding funds in an aggregated reserve or escrow account. Through the modernization of technologies that allow paperless account-to-account financial transactions, healthcare sharing networks can implement a peer-to-peer (member-to-member) sharing methodology by transferring funds directly between member accounts. By adopting an account-to-account method to satisfy regulatory statutes that require member-to-member sharing, sharing networks are able to clearly demarcate themselves from the practice of insurance, while at the same time enabling themselves to build and sustain reserves that equal the fiscal soundness of the insurance model.

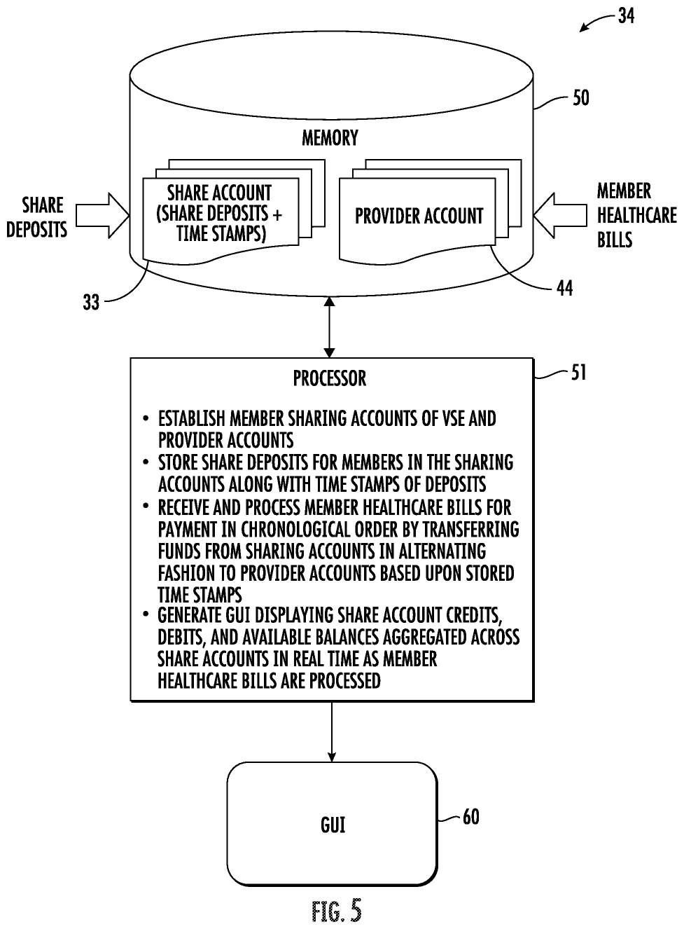

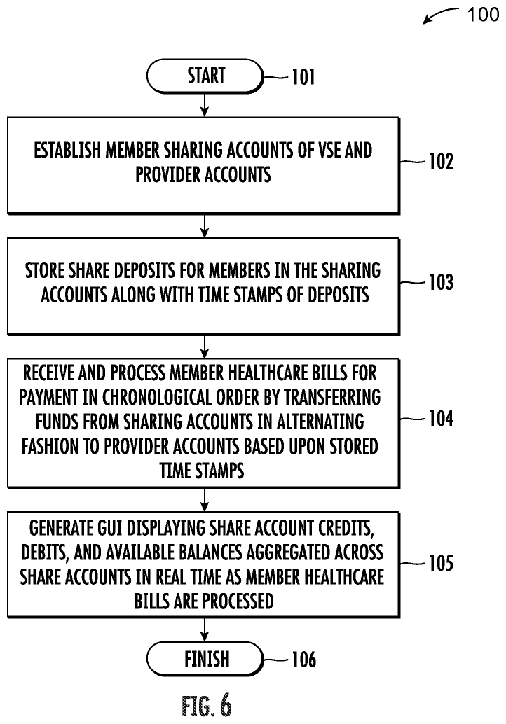

Referring to FIG. 5 and the flow diagram 100 of FIG. 6, an example embodiment of the computing device 34 is now described which illustratively includes a memory 50 and a processor 51 configured to cooperate with the memory to perform the operations or steps described herein. Beginning at Block 101, the processor 51 establishes member sharing accounts 33 for respective members 36 of the VSE 30 for sharing payment of member healthcare bills (including, optionally, reserve requests 41) across the member sharing accounts, and provider accounts 44 for healthcare providers 45 issuing the member healthcare bills, as discussed above (Block 102). The processor 51 may further store share deposits for the members 36 in the sharing accounts 33 along with time stamps of the share deposits, at Block 103, and receive member healthcare bills 38 issued by medical providers 45. The processor 51 further processes the member healthcare bills 38 for payment in chronological order by transferring funds from the different sharing accounts 33 in an alternating fashion to the provider accounts 44 based upon the stored time stamps for the deposits, at Block 104, and generates a GUI 60 displaying share account credits, debits, and/or available balances individually or aggregated across the share accounts in real time as the member healthcare bills are processed, at Block 105, as will be discussed further below. The method of FIG. 6 illustratively concludes at Block 106.

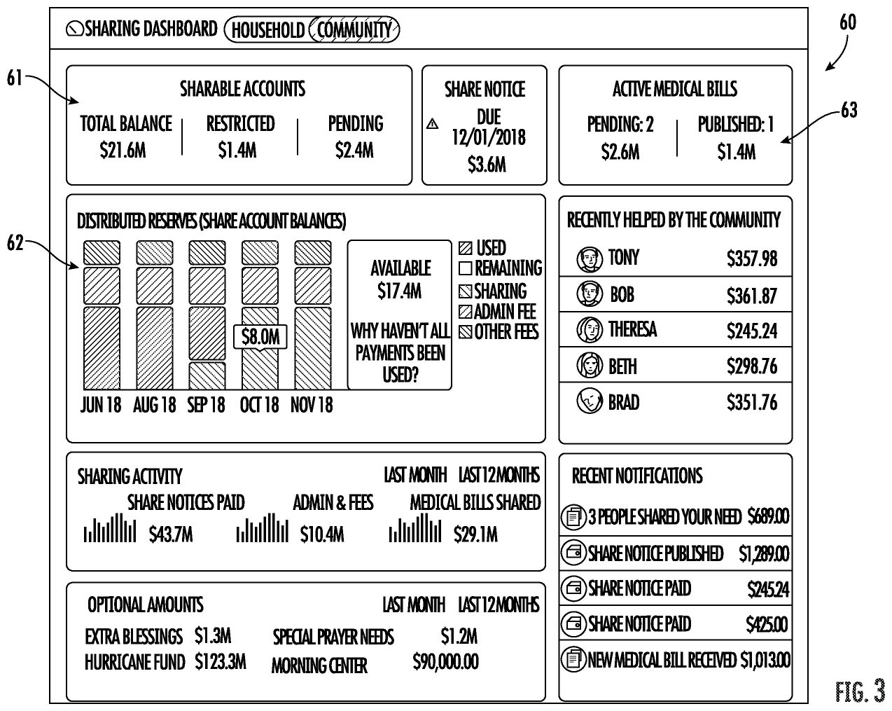

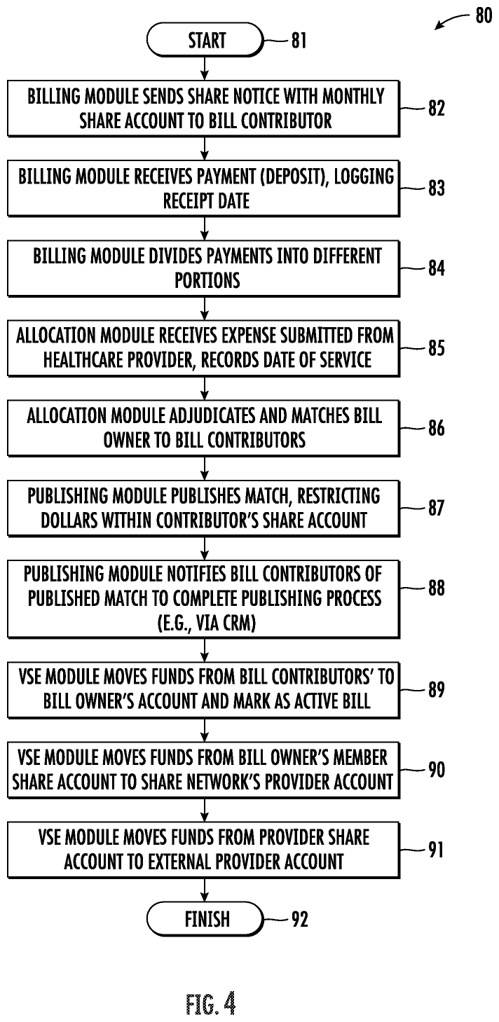

Referring now additionally to FIGS. 2-3 and the flow diagram 80 of FIG. 4, an example implementation of the VSE platform 31 is now described which advantageously allows sharing networks to execute a sharing model that gives members control over their personal funds which are electronically stored within their VSE share accounts 33 until such a time the funds are utilized for another member's healthcare needs. This approach helps ensure an equitable draw on member accounts by prioritizing a use of funds that matches and allocates the oldest monies received to oldest bills by service date. Thus, the VSE 34 will order and display, by default, the distribution of unutilized funds (i.e., available balances) by month of funds received. As funds go unutilized, they remain in the member-controlled share account 33 within the VSE 34, which effectively builds a type of “reserve” for the benefit of the members of the network.

A VSE graphical user interface (GUI) 60 displays a detailed accounting of the member's share account 33 including each instance of their deposited funds via share notice payments, as well as any transfers to other members 36 for the purpose of sharing. These account activities and any remaining balances are marked, distributed and displayed by month in every member account. The GUI 60 also displays an accounting and distribution of all member balances, at an aggregate level, in order to provide the necessary transparency to satisfy regulatory statutes. Yet, this is done while giving the members of the network a clear view and confidence into the number of medical reserve months held in member accounts 33.

In accordance with the present example, the VSE platform 31 advantageously invoices and collect funds, holds the collected funds in specified accounts, and matches and allocates the oldest funds with the oldest bill in a manner that prevents the sharing network from taking receipt of or otherwise pooling the funds. Beginning at Block 81, members 36 in the share network 40 may make contributions on a recurring basis, most commonly on a monthly basis. The billing module 49 sends members 36 a notice (Block 82), which is also referred to as a “share notice”, of their monthly share amount. The monthly share amount may be determined by aggregating the individual line items, or “portions”, as determined by the program the member 36 is participating in. In the illustrated example, as payments for the monthly share notices are received (Block 83), the billing module 49 divides the payments into two different portions, at Block 84. A first portion is for sharing in the approved medical needs of other members 36, and the second is for the general administrative fees and services to facilitate the program.

The monthly share amount funds may be remitted by the member 36 via the VSE's banking module 35. As the funds come into the VSE platform 31, they appear on the member's GUI portal 60. Through an integration with the VSE's billing module 49, the banking module 35 automatically moves the appropriate amount of funds into distinct, corresponding virtual accounts as indicated. For the funds related to the portion for administrative fees and services, they are moved to a corresponding share network account 39. Funds held in the share network accounts 39 are owned and managed by the sharing network 40 and may be withdrawn from the VSE platform 31 into an external account at any point by the sharing network.

Funds related to the portion for sharing approved medical bills are held in individually owned member shared accounts 33 within the VSE module 37. While these member share accounts 33 are indeed owned and controlled by the members 36, the member permits the share network 40 to move funds in and out as needed for the purpose of sharing approved medical bills. During the normal course of operations, it is common for there to be more available funds within the member share accounts 33 across the entire VSE platform 31 than what is needed immediately for approved medical bills. Therefore, the surplus stays within these individual member share accounts 33 that are owned and controlled by the individual members 36. That surplus effectively serves as a type of “reserve”, yet is never received, held or owned by the share network 40.

This approach of having a surplus serve as a type of “reserve” maintained within the individually-owned member share accounts 33 uniquely benefits the share network 40 in a number of ways. This allows for building of reserve funds to a targeted level by establishing monthly share amounts that are greater than the actual flow of approved medical bills 38 (and/or reserve requests 41). Moreover, it allows for the distribution of the surplus into member owned accounts 33, thereby avoiding any “pooling of funds” in a centralized account (an attribute of insurance networks). Furthermore, this approach allows for the retention of the surplus while not taking receipt of the funds (another attribute of insurance networks) in the event of an influx of approved medical expenses.

As members 36 remit their monthly share amounts indicated on the monthly share notice (Block 83), the member can see the record of the payment within their member portal GUI 60. Within the member portal GUI 60, the member 36 can easily see their individual household's sharing contributions within a sharable account section 61. A share notice payments section 62 illustratively displays the total dollars that have been collected for specified portions on the monthly share notice for a given month and further clarify if a surplus exists.

In order to ensure funds can be retained for the utilization of sharing in approved medical bills 38, despite having a total balance within the share account 33, some dollars may be restricted as shown in the sharable account section ($300 of a total balance of $1,646 in the present example). Restrictions within a share account 33 may occur because the allocation module 42 has matched funds (Blocks 85-86) from a given share account 33 to be used for an eligible medical bill 38 (or reserve request 41). Further restrictions may occur if funds have been deposited into an individual share account 33 to provide for any of the approved medical bills 38 that may be active, as shown in an active medical bill section 63 of the GUI 60, and belong to the family that owns the share account.

In FIG. 3, a community view of the GUI 60 is provided, as opposed to the household/member specific view showing FIG. 2. Here, the VSE module 37 presents data relevant to the entire community, not simply an individual. As members 36 remit their monthly share amount indicated on their individual monthly share notices, the membership as a whole can see the record of the payments within their member portal GUI 60. Within the GUI 60, the member 36 can easily see their entire community's sharing contributions. The aggregated amounts within the individual share accounts 33 may display in the section 62 the total dollars that have been collected for specified portions on the collected monthly share notices for a given month, and further clarify if a surplus exists. Moreover, displaying of the surplus in the GUI 60 may be distributed by month deposited, which ultimately indicates the number of sharing months that have been built-up by the network 40 and its community.

In order to determine which dollars within a share account 33 are to be used in paying approved medical bills 38, sharing networks 40 on the VSE platform 31 may match and allocate the oldest received dollars with the oldest approved medical bill. This approach to sharing is called FIFO Sharing, or first-in-first-out. A FIFO sharing process is executed by tagging monthly share deposits by the date they are deposited into the member share accounts 33 and tagging medical bills by the date that the service was rendered by the provider. Matching and allocation algorithms are then used to prioritize oldest deposited money against the oldest bills 38. That is, the VSE module 37 removes funds from the share accounts 33 in an alternating fashion, e.g., withdrawing available funds with the oldest time stamp from a first bill contributor's account 33, then moving to a second deposit in another bill contributor's account having the next oldest time stamp, etc.

By deploying algorithms that match and allocate funds by oldest dollars received to oldest bills 38 received, sharing networks 40 are enabled to facilitate an equitable draw of funds (available balances) that are distributed and held in member accounts 33. Moreover, because this is done in an automated fashion by the computing device 34, it can be performed in real time to maintain the equitable accounting across a large member base at all times, which would otherwise not be possible with manual accounting practices. Again, this is important in a VSE context because funds cannot be simply set aside in a pooled account as in an insurance network model, but instead need to be maintained within individual member accounts up until the time funds are shared to pay another member's healthcare bill. Yet, the computing device 34 still provides for accurate and timely monitoring and forecasting across the VSE platform 31 to ensure that overall reserve levels are met, while also allowing members a transparent view into the overall state of the VSE 30 and their respective accounts 33 at any time.

This equitable draw helps ensure that all September funds held in member accounts are matched and allocated before any October funds are drawn, for example. Thus, the FIFO sharing process enables the VSE platform 31 to distribute and display balances in the individual member account 33 by month, as well as distribute and display funds held in all member accounts on an aggregate basis by month. By distributing and displaying the aggregate member balances by month, members of the sharing network 40 can easily see the number of sharing months that have been built, reserved and held by the community of members 36.

Once the matching of funds to a bill occurs, as part of the publishing process (Blocks 87-88), the publishing module 43 restricts the dollars accordingly in the contributing member's share account 33. Each share network 40 may have its own protocol for how notification to contributing members is executed, e.g., via the share network's customer relations management (CRM) tool. Bills matched, allocated and published (i.e., notification) for sharing remain in a published state for a period of time (e.g., three days), which may be configured by the share network 40. This is called the “publishing period”. The publishing period satisfies additional regulatory requirements by giving notice of sharing before funds are transferred and allowing members to withdraw from membership before funds are transferred. Thus, the publishing of matched bills 38 and the allocated publishing period satisfies the “voluntary sharing” requirement of most regulatory statutes. After the publishing period is satisfied, the restricted funds are then moved (Block 89) into the recipient's share account 33. Those moved funds would now appear as used in the GUI 60. The moved funds are similarly restricted to the recipient and indicated as an active bill (section 63) until they are moved into the provider account 44 (Block 90), and subsequently to the medical provider's external account 45 (Block 91). The method of FIG. 4 illustratively concludes at Block 92.

The above-described distributed reserving process may accordingly dynamically calculate and bill monthly share amounts greater than the average monthly amount needed to pay medical bills. For further details, see co-pending application no. U.S. application Ser. No. 16/876,736 noted above. This enables the sharing network 40 to build reserves by collecting more than what is needed to pay the outstanding member bills 38. Furthermore, the above-described approach also allows for the collection of monthly share amounts in member owned and managed share accounts 33, and thus sharing network 40 avoids the insurance practice of “pooling” funds by not taking receipt of the funds. Instead, the VSE platform 31 builds, holds and distributes the reserves (available balances) in member owned accounts 33.

In addition, the VSE platform 31 also time stamps the deposits (monthly share amounts) by date collected and medical bills by the date of service so that the sharing network 40 can enable a FIFO sharing process, as discussed further above. By having the VSE platform 31 match and allocate medical bills by oldest money to oldest bills (FIFO), the sharing network 40 can facilitate an equitable draw on member held funds, as well as display member held funds (reserves) on a monthly basis.

Furthermore, the VSE platform 31 may also display share account 33 credits (deposits), debits, and available balances by month on an individual member level, as well as on a community level. The individual level advantageously helps members 36 to see their individual available balance distributed by month. Displaying share account credits (deposits), debits, and available balances by month on an aggregate community level allows members 36 to see the number of available “sharing” months that have been built-up and reserved, and to understand how the available balance in their individual account is used to build and retain reserves.

The VSE platform 31 uniquely accommodates the creation of member-owned and controlled financial accounts 33. By being independently owned and therefore controlled by the members 36 within the share network 40, these accounts receive the same level of insurance protection awarded to the other accounts. By leaving balances within the share accounts 33, the share network 40 is able to build and sustain reserves while never taking control or ownership of the funds.

The approach set forth herein provides a detailed view (GUI) of the member's share account 33 that clearly shows the distribution of the dollars in their account. Prior to being allocated by the VSE platform 31, the funds belong to the member, therefore it is important for the VSE platform to show the appropriate ledgering and utilization of the funds. This approach also provides a detailed view of a member's share account 33 that indicates distributed funds received and funds used by month. When the member 36 receives the share notice, the share notice indicates the portions the member previously agreed to. The GUI 60 provides confirmation that the share network 40 utilizes the contributing member's funds as intended.

The VSE platform 31 also provides a display within the member account 33 that allows the member 36 to see a detailed view of dollars available within the community as a whole. This enables the members 36 to know the dollars already being utilized for medical bills 38 (and optionally reserve requests 41), and it can also show the reserves by date received currently distributed among the entire membership.

In addition, the VSE platform 31 may use the available funds persisting in the share accounts in the order received. Once a bill is ready to be paid, the allocation module 42 will order the allocation based upon the service date of the medical procedure. This “first-in-first-out” model for both utilization of the reserves as well as the allocation of the funds provides an equitable and fair draw amongst the reserves.

As such, the VSE platform 31 advantageously enables sharing network 40 to build and sustain bill reserves (similar to insurance networks), but to do so in a way that is different from the insurance network approach to building reserves (i.e., decentralized vs. centralized), and while complying with regulatory statutes that prohibit the unlawful sale of insurance. Moreover, the VSE platform 31 also enables sharing network 40 to build and sustain bill reserves without taking receipt of member funds, as the funds are held and owned by the members 36, not the sharing network.

Moreover, the VSE platform 31 also enables the equitable draw and use of funds in the member share accounts 33, e.g., September money is used before October money is used. This also enables the sharing network 40 to build confidence from its members by distributing and displaying the number of sharing months that are being held in all the member accounts 33. This also enables visibility and transparent use of member 36 funds contributed to the VSE 30.

As noted above, the VSE platform 31 may be implemented using one or more computing devices 34 such as servers, network interface devices, client devices, etc., including the appropriate hardware (e.g., processor, memory, etc.) and software having non-transitory computer readable instructions for performing the operations discussed herein. Moreover, in some embodiments the VSE platform 31 may be implemented within a cloud computing network. As noted above, it will be appreciated that the systems and methods set forth herein may also be used with other types of cost or expense sharing platforms besides healthcare sharing networks. That is, VSE platform may also support other share networks beyond just health care sharing, such as veterinary bills, automotive or appliance repairs, etc.

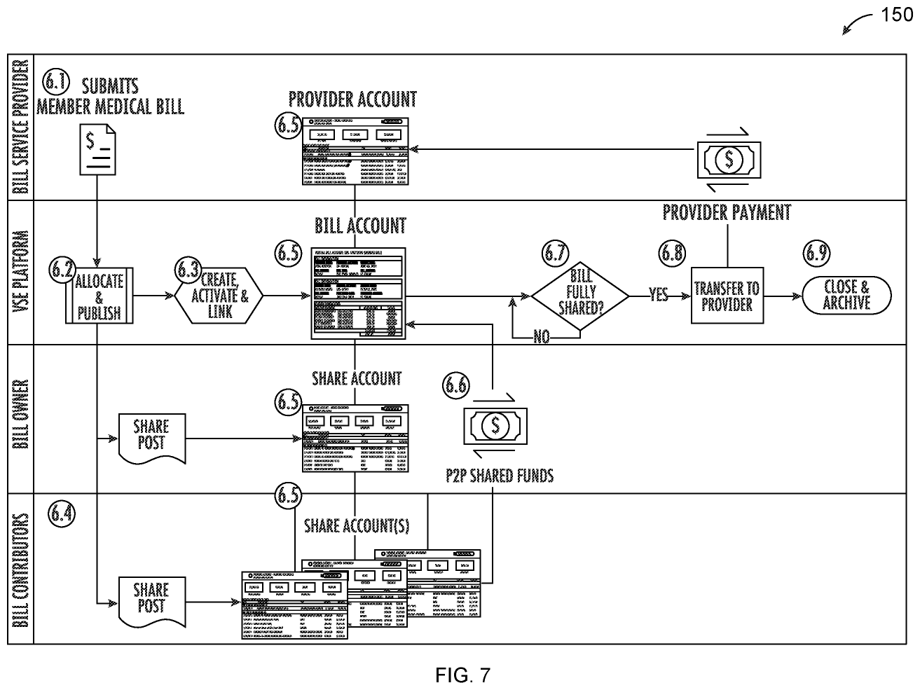

Referring additionally to FIG. 7, the computing system 30 may also advantageously provide for the generation of virtual bill accounts to link payment sharing sources with the service provides in a manner that allows for accessibility and electronic fund transfers as if the virtual bill account was a stand-alone bank account, yet this may be done in an automated fashion and “on the fly” as member healthcare bills are received.

Despite the rapid growth of sharing networks, especially healthcare sharing networks, healthcare sharing networks have traditionally not had the technical ability to incorporate medical providers within the sharing network environment. However, the VSE platform 31 advantageously allows for medical providers to be incorporated into the process of healthcare sharing through the use of virtual bill accounts 46 implemented by the VSE module 37 to enhance provider visibility and remit payments for bills in a manner that is more efficient for the provider community.

More particularly, the VSE platform 31 equips medical providers, and other potential stakeholders, to actively participate in the process of healthcare sharing, as well as provide greater transparency into the sharing transactions related to a member's medical bills. Generally speaking, the medical provider community has been cautious to embrace a concept where the payor is not an insurance company or the patient making a cash payment. Other than the care that they provide to their patients, a medical provider's primary concern is to make certain that they get paid for the care provided. Whereas, insurance companies are obligated to pay providers per the terms of a contract or a “cash pay patient” can be required to pay by credit card or payment terms before services are rendered, medical providers maybe more cautious of placing trust in a healthcare sharing network and its members to remit payment for a patient's bill.

While the movement of patients (i.e., members 36) towards healthcare sharing has not been slowed by provider caution, sharing networks may further benefit when providers are assured of a network's “ability to pay” their patient's medical bill by gaining access and visibility into the sharing process. As healthcare sharing continues to grow and the provider community will engage and serve even larger numbers of members, they are more likely to embrace sharing networks who provide transparency and demonstrate the intent and ability to pay member bills.

Thus, the VSE platform 31 advantageously provides a computing architecture that incorporates medical providers into the sharing process of their patient's bills within the sharing network. The approach described herein may replace the process of member-to-member (or P2P) sharing that is practiced in earlier generations of VSEs. Where earlier generations facilitated P2P sharing through direct transfers between member share accounts, the VSE platform 31 implements P2P sharing through virtual bill accounts 46 that are uniquely linked to (1) the member share account of the bill owner, (2) the member share accounts of bill contributors, and (3) the provider account of the bill service provider who submitted the bill. For example, the virtual bill accounts 46 may be established within a database architecture in which the unique IDs of members 36 and/or member accounts 33 are linked to a unique table that is created on the fly to define the virtual bill account responsive to the submission of a medical bill 38 to be funded.

The use of virtual bill accounts 46 enables sharing networks to integrate and engage any number of stakeholders associated with the payment of a member bill or obligation. A virtual bill account is a single purpose virtual account and ledger within the VSE/FBO Module 37 that is created for a specific purpose and is linked to those members of the network, and third parties, who have an interest in the purpose of the newly created account. Transactions in the virtual bill account 46 are made viewable to some or all stakeholders who hold their own accounts within the VSE/FBO Module 37. Funds in the virtual bill account 46 are restricted (unavailable) until the single purpose of the account has been completed and funds are released to the intended stakeholder.

In the case of the VSE platform 31 supporting a healthcare sharing network, a virtual bill account 46 is a temporary account that is opened when the VSE platform receives a member medical bill 38 and then matches, allocates and publishes the bill for sharing. The virtual bill account 46 is linked at least to the member share accounts 33 of the bill owner and bill contributors. The medical provider that submitted the bill is a stakeholder in the sharing process and gains access by establishing a provider account 44 on the VSE platform 31. Other potential stakeholders might be P2P lenders (members), or third-party lenders who desire to assist members in paying bills not shared by the network, for example. The virtual bill account 46 is not a sub-account of any one stakeholder. Rather, the virtual bill account 46 is a temporary single purpose account that is linked to potentially multiple stakeholders. Funds collected in a virtual bill account 46 are restricted and unavailable dollars, but can be displayed as “pending” (unsettled) transactions in more than one stakeholder's account.

Thus, sharing networks can invite and engage medical providers into the sharing process by providing them with a provider account 44 that displays both a pending and available balance and sums the active amount of their patient bills submitted to the network. The “pending” balance is restricted and represents the total patient bill amounts that are in the process of being published, shared and transferred to their respective virtual bill account 46. The “shared and available” balance is unrestricted and represents the total patient bill amounts that have been shared in a virtual bill account and can now be withdrawn by the Provider.

Virtual bill accounts 46 are equipped with a linking feature that enables sharing networks to uniquely display numerous sharing transactions related to a member medical bill 38 as a single sharing transaction in the member share accounts 33 of the bill owner, bill contributors and bill service provider. For example, Bob's bill for a $50,000 knee replacement surgery gets matched, allocated, published and shared by 200 members who contributed $250.00 each. The 200 transactions can be displayed in Bob's share account 33 as a single $50,000 “restricted” credit. If Bob desires, he can click on the $50,000 transaction in his GUI to display the virtual bill account 46 and have it display the names and amounts that each member contributed, as will be discussed further below. Likewise, the provider account of Bob's surgeon can display a $50,000 “pending” credit in his provider account 44 until all monies are settled and can be electronically transferred to Bob's surgeon's bank account. Like Bob, the surgeon can click on the $50,000 transaction in his GUI to display the virtual bill account 46 member contributions as well.

Virtual bill accounts 46 may accordingly provide enhanced flexibility, transparency, and security. Moreover, levering the capabilities of virtual bill accounts 46 will enable new VSE features that will be embraced by providers, such as provider direct payments and P2P loan requests, where members assist each other in paying bills that are ineligible for sharing, as will be discussed further below.

The virtual bill accounts 46 may be dynamically activated and deactivated by the VSE platform 31 for the purpose of sharing and paying a given member medical bill 38 by coordinating the sharing transactions between the bill member and bill contributors, and the transfer of payment to the bill service provider. The VSE platform 31 integrates several technical advantages in the computing system 30. For example, as an Evolution of P2P Sharing (Member-to-Member), the virtual bill accounts 46 provide an automated approach enabling sharing networks to facilitate P2P sharing transactions. This is important for healthcare sharing networks that are required by many states to voluntarily share funds from member-to-member. More particularly, first generation of VSE platforms enabled P2P sharing by moving funds member-to-member through the use of physical bank accounts or notional accounts inside of a custodial/escrow structure. That is, first generation P2P sharing consisted of matching and allocating funds held in the share accounts of a bill contributor, and then moving those funds directly to the share account of the bill owner.

On the other hand, the virtual bill accounts 46 advantageously allow for the replacement of direct transfers between member share accounts with the use of single purpose accounts that are automatically spawned and closed by the VSE module 37 on demand. That is, the VSE module 37 dynamically creates and activates single purpose virtual bill accounts 46 to coordinate sharing transactions for a specific medical bill 38. In this approach, P2P sharing is facilitated through a virtual bill account 46 that is dynamically activated by the VSE module 37 whenever a bill is allocated and published for sharing, and then deactivated when the bill has been shared and resolved.

The VSE platform 31 equips sharing networks to dynamically create a virtual bill account 46 whenever a specific medical bill is allocated for sharing. The virtual bill account 46 is created to coordinate sharing for a specific medical bill 33. The virtual bill account 46 is linked to the accounts 33 of the bill owner and the bill contributor(s), and optionally to the account 44 of the service provider as well. The virtual bill account 46 is used to collect funds from a bill contributor who has been matched to share in the specific bill for which it was created. The use of virtual bill accounts 46 is a contemporary Fintech approach to voluntary member-to-member sharing. The virtual bill account 46 enables member-to-member sharing transactions for large medical bills that can span hundreds of bill contributor accounts 33 (or more) by providing a detailed and auditable ledger of all related sharing transactions.

As noted above, first generation P2P sharing was executed through VSE platforms that used physical bank accounts as member share accounts. In some instances, notional accounts inside of a custodial/escrow structure were used as share accounts. In both scenarios, sharing transactions moved directly from one member's share account to another member's share account. However, physical bank accounts or notional accounts created technical challenges that virtual bill accounts 46 resolve. Sharing through physical bank accounts, for a community of hundreds of thousands of members (or more) can be extremely expensive, complex and cumbersome.

Sharing through notional sub-accounts within an escrow structure is less expensive, less complex and more manageable for large communities. However, notional sub-accounts are not addressable and do not provide sharing networks with the ability to draw checks or Automated Clearing House (ACH) transactions against the share accounts (i.e., notional sub-accounts). An additional concern is the fact that notional sub-accounts that serve as member share accounts cannot be managed or controlled by the member. Thus, sub-accounts might fall short of a regulator's strict definition of voluntary member-to-member sharing.

Virtual bill accounts 46 are relatively inexpensive to implement and relatively easy to manage and use, plus they are addressable. More particularly, each virtual bill account 46 has an externally addressable routing and account number from which checks and ACH transactions can be drawn. The VSE platform 31 accordingly may incorporate recent Fintech developments in virtual account management and ledgering to facilitate a more advanced form of healthcare sharing. In the VSE platform 31, all accounts that are created and activated within the VSE module 37 enjoy the benefits of a physical bank account. Member share accounts 33, provider accounts 44 and virtual bill accounts 46 all reside within the VSE/FBO Module 37, which may be implemented within a single physical bank account held by a financial institution. The FBO account at the financial institution is held and titled “for the benefit of” the sharing network's members 36. All account transactions within the VSE/FBO account are “on us” transactions and are simple to initiate and manage, and may be done for relatively little or no cost.

This VSE platform enables the automated creation, activation and deactivation of numerous addressable single purpose virtual bill accounts 46 for each medical bill 38 submitted to the sharing network. This advantageously allows a healthcare sharing network with the ability to create a virtual account and ledger for every unique medical bill published and shared by the community. Moreover, each virtual bill account 46 within the VSE/FBO module 37 is externally addressable with a routing number and account number, as noted above. This enables the VSE module 37 with the ability to coordinate and ledger sharing transactions between bill owners and bill contributors and then, through the use of the addressable account number, transfer funds as payment to the provider account 44 that resides inside of the VSE module, or another account that reside outside of the VSE module in a physical bank account with any bank. This enables the ledgering and full reconciliation from the beginning point of publishing a bill for sharing to the end point of paying a provider who exists inside or outside of the sharing system.

The virtual bill accounts 46 are single purpose accounts that are dynamically created and activated within the VSE/FBO module 37 for a specific purpose (which, in the present example, is paying a given medical bill 38), and thereafter they are deactivated and archived whenever that specific purpose is complete. This process will now be described further with reference to the sequence flow diagram 150 of FIG. 7.

The bill service provider (medical provider) submits the member's medical bill 38 to the sharing network for payment, at step 6.1. Next, the VSE module 37 matches, allocates and publishes the member's medical bill to the network's members 36 for sharing, at step 6.2. The VSE module 37 further dynamically creates and activates a single purpose virtual bill account 46 for coordinating the sharing, collection and payment of the member medical bill, at step 6.3. The VSE module 37 may further send a notification called a share post (step 6.4) to both the bill owner and the bill contributor(s). The bill owner is notified that their bill has been published for sharing, as well as the name of and amount that each bill contributor will contribute. The bill contributors are notified as to whose bill they have been matched with, and the amount that they have been allocated to contribute.

The VSE module 37 links the share accounts 33 (step 6.5) of the bill owner and the bill contributors to the virtual bill account 46, as well as the provider account 44 of the bill service provider (step 6.5). Moreover, the VSE module 37 transfers funds (step 6.6), after the publishing period has ended, from the share accounts 33 of the bill contributors to the virtual bill account 46 for the single purpose of sharing and paying the given member medical bill 38.

The VSE module 37 monitors all sharing transactions and collections (step 6.7) in the virtual bill account 46. The virtual bill account 46 remains open and active until sharing transactions, equal to the published amount, have been received. Once the member medical bill 38 is fully funded, the VSE module 37 transfers the balance (step 6.8) of the virtual bill account to the provider account 44 (or outside of the VSE module) as the network's approved payment for that bill. Once all funds have been transferred to the provider's account, the VSE module 37 automatically deactivates and archives the virtual bill account 46 (step 6.9) with detailed member-to-member sharing transactions for the bill.

The virtual bill accounts 46 act as an auditable ledger for a multi-stakeholder transaction that extends over a period of time. As previously noted, a virtual bill account 46 serves as the ledger of multi-party transactions related to a single purpose for which it was created, and it is temporary in that it is not a perpetual account. The virtual bill account 46 has a “beginning and end” of the purpose for which it was created. In the case of healthcare sharing, a virtual bill account 46 can be used to register transactions for multiple purposes across multiple stakeholders related to the sharing network and its community.

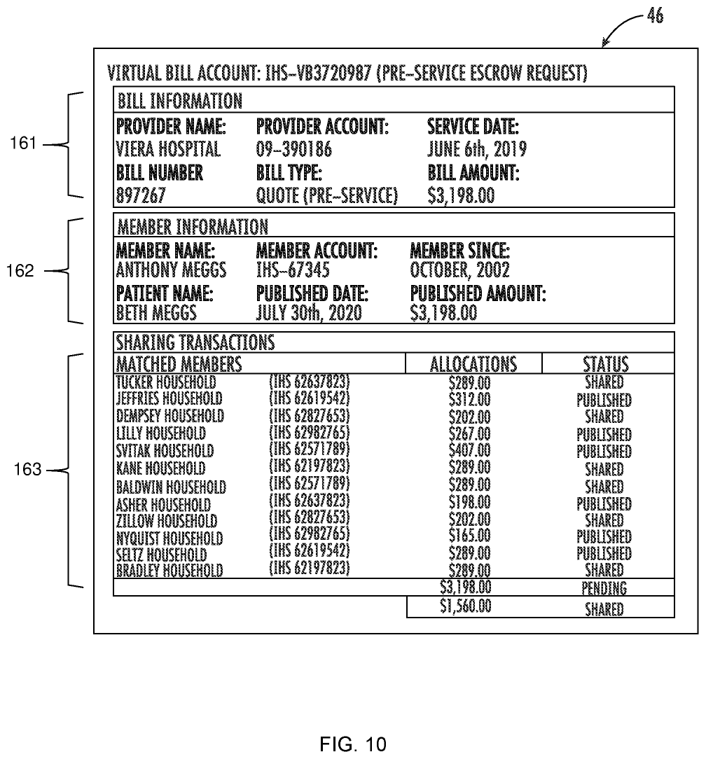

Virtual bill accounts 46 may be used to share pre-service invoices or escrow requests 41, as well as post-service bills 38. In the case of a post-service bill 38, the virtual bill account 46 serves as a ledger for the single purpose of coordinating and registering all sharing transactions for a “post-service” bill (FIG. 10), and then coordinating and registering the transfer of the account balance to a provider account 44 as payment to the medical provider for a fully funded medical bill. Serving as the ledger for sharing transactions related to a specific post-service bill 38 may typically be the primary use of virtual bill accounts.

However, in certain instances sharing of a pre-service member bill (escrow request) 41 may also be appropriate. In the example of FIG. 10, a virtual bill account 46 serves as a ledger for the purpose of coordinating and registering sharing transactions for a pre-service bill 41, or what might otherwise be considered as a quote for medical services. In some instances, medical providers might require a pre-payment or escrow of funds before services are rendered. This is especially true with large bills. The VSE module 37 may advantageously be configured to facilitate pre-payment terms by publishing a quoted amount and then registering the sharing transfer of funds into a virtual bill account 46 that is linked to the provider account and made visible to the provider that is providing care. Once proof of services rendered has been obtained to the satisfaction of the sharing network, funds that are being held (escrowed) are released and transferred to the provider account 44.

Still another use for the virtual bill accounts is for enabling P2P “micro” loans for paying member responsibilities. More particularly, a virtual bill account 46 can serve as a ledger for coordinating and registering loan and repayment transactions related to a P2P loan from network members that is needed to pay a specific member medical bill. It is typically the case in healthcare sharing that a member is often required to pay a first-dollar portion of an eligible medical bill. This is most likely to be in the form of a deductible or a co-share amount. There are also times when all or a portion of the medical bill is ineligible to be shared by the members. This usually takes the form of ineligible procedures or caps on eligible procedures. In both scenarios, members are often in need of a lending source in order to pay these amounts, which are often referred to as the member responsibility amount. The member responsibility amounts are not shared by the other members 36. Just as an eligible bill amount can be matched, allocated and published to members by the VSE module 37, so too can a loan request be matched, allocated and published to multiple members 36 willing to lend a portion (a micro-loan) of the loan request to the member for a profit. Because of the unique account linking properties of a virtual bill account 46, they are well suited for maintaining a ledger of P2P micro-loans related to the member responsibility amount for a particular bill 38.

Another advantageous feature of the virtual bill accounts 46 is that they can be linked to the virtual accounts of stakeholders who hold interest in the purpose for which the account was created. To engage and benefit from this account linking feature, stakeholders open and maintain their own virtual accounts within the VSE system.

In the case of healthcare sharing, to engage the medical provider community and invite them into the sharing network, medical providers may create and activate their own provider accounts 44 in the VSE platform 31 to enjoy the full benefits and features of virtual bill accounts 46. Providers may open accounts with individual sharing networks, or open an account with a Payment service that integrates with the VSE platforms 31 of multiple networks. In doing so, medical providers can gain access and visibility into the status and progress of their patient bills, as well as gain access to their patient payments as soon as those bills are shared.

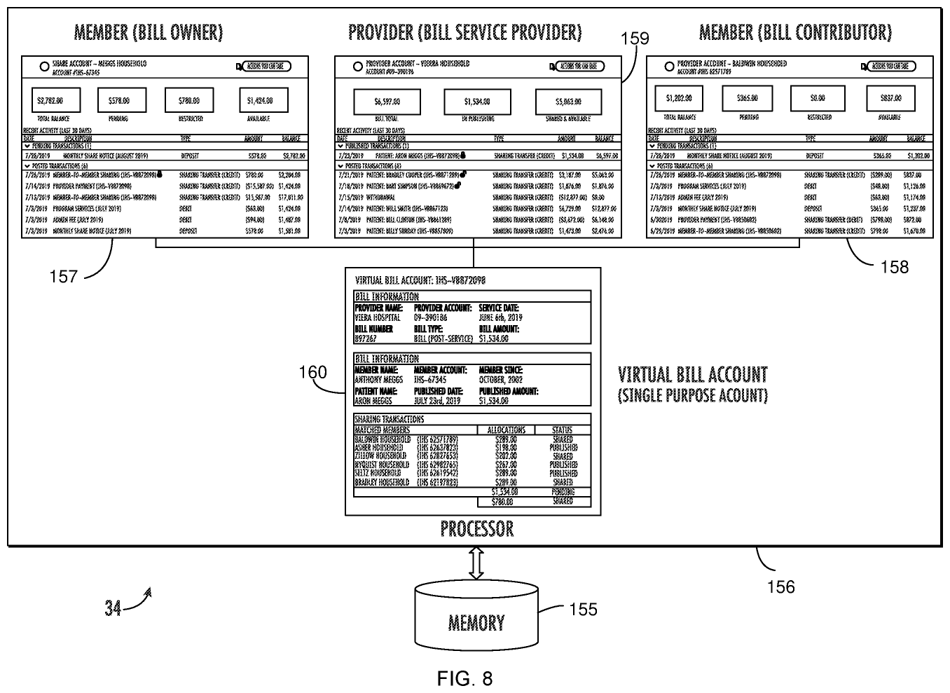

In the example of FIG. 8, the server 34 illustratively includes a memory 155 storing non-transitory computer executable instructions, and an associated processor 156 which cooperates with the memory to operate the VSE platform modules 35, 37, 42-43, 49, and perform the associated steps described herein based upon the stored instructions. In the illustrated example, the processor 156 generates respective graphical user interfaces (GUIs) 157, 158, 159 for the bill owner, bill contributor, and bill service provider. Moreover, the processor 156 also generates a GUI for displaying the virtual bill account 46 ledger information, which is accessible by all of the bill owner, bill contributors, and bill service providers.

Whenever the VSE platform 31 creates and activates a virtual bill account 46 to coordinate P2P sharing transactions, it links the virtual bill account to the share account 33 of the member 36 who is the bill owner and the share account of the member(s) who has been matched and allocated as bill contributor(s). In the illustrated example, the virtual bill account is not a sub-account of any account 33, 44 held by the bill owner, bill contributor, or bill service provider. The virtual bill account 46 is instead a linked account, in that it is an addressable virtual account held in the VSE/FBO module 37 for the single purpose of sharing and funding the given bill 38 (or pre-service request 41).

The account linking feature of virtual bill accounts 46 may advantageously enable a desired level of visibility, transparency, accountability and flexibility into the P2P sharing process not yet achieved with prior VSE configurations. Linking virtual bill accounts 46 to stakeholder accounts 33 enables sharing networks to engage bill service providers into a linear sharing and payment process that spans time. Virtual bill accounts 46 engage bill service providers by enabling sharing networks to display their patient bills and the state of sharing progress as pending transactions in their provider accounts 44. This is especially useful in the healthcare sharing context, as medical providers can watch their patient bills 38 be submitted, matched, allocated, published, shared and paid by the sharing network and its community of members.

The virtual bill accounts 46 also enable a multi-transactional view into a P2P sharing process that can span time and multiple stakeholders. Linking a virtual bill account 46 to its related stakeholders enables a sharing network to build stakeholder account views that display “pending” or “in progress” transactions that provide transparency into the process.

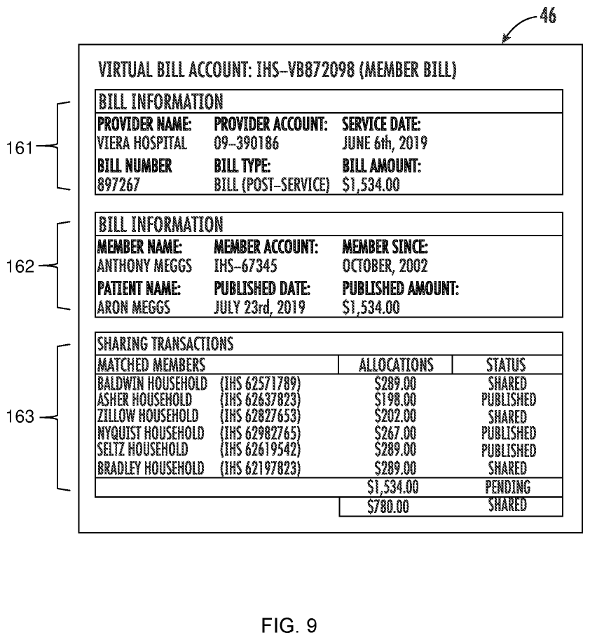

In the present example of healthcare sharing, linking the share accounts 33 of bill owners and bill contributors to virtual bill accounts 46 enables sharing networks to create share account views through GUIs 157-160 that bring enhanced visibility and transparency to healthcare sharing. In the example of FIG. 9, a temporary virtual bill account 46 has been created and activated by the VSE platform 31 for the purpose of coordinating sharing transactions for a specific member bill 38. The member information section 162 indicates that a bill of $1,534.00 has been received, matched, allocated and published by the VSE platform 31 to be shared by network members. The network member is Anthony Meggs and the bill is for Aron Meggs who is a member of the Meggs household. The virtual bill account 46 has been linked to Anthony Meggs (the bill owner) as indicated by the member account number.

The sharing transactions section 163 indicates that (6) six member households have been matched to share in the Meggs medical bill 38 and they have each been allocated a certain amount to be transferred (debited) out of their share accounts and credited to the share account of the bill owner (Meggs). This section also indicates the progress status of each individual allocation. Thus far, $780.00 have been transferred from the share accounts of three bill contributors, settled in the virtual bill account 46, and credited to the share account of the bill owner (Meggs). The remaining three allocations are still in the “published” status. The share accounts of all six contributors have been linked to the virtual share account 46, as indicated by member account numbers displayed with each allocation. As will be discussed further below, bill information section 261 indicates that the medical bill was submitted by Viera Hospital (the bill service provider), and the provider account 44 of the bill service provider has been linked to the virtual bill account 46, as indicated by the provider account number. So, in the present example, the virtual bill account 46 has been linked to eight different stakeholders, namely the bill owner (1), bill contributors (6), and bill service provider (1).

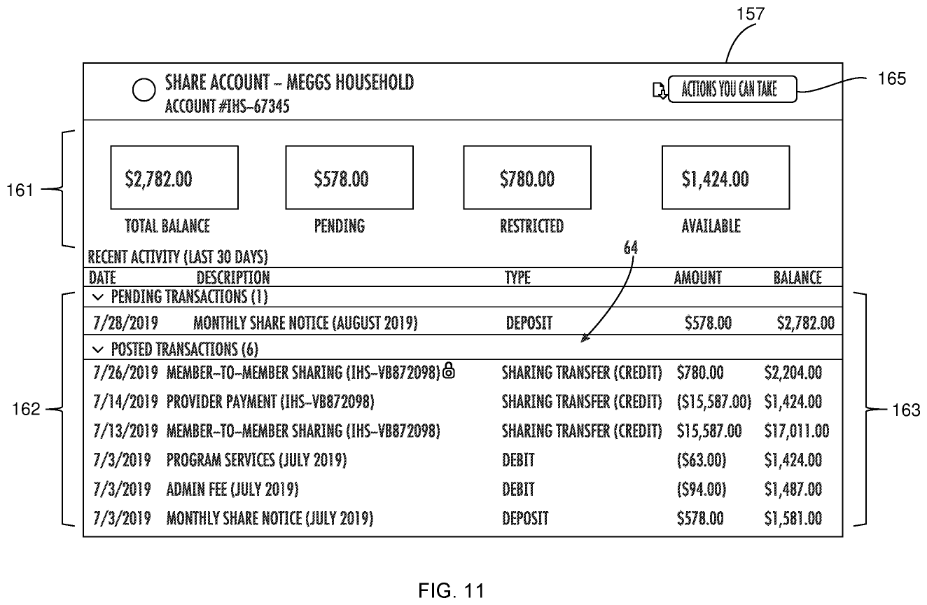

The links enable the sharing network to create and provide members 36 with a unique view into the P2P sharing process that transacts through their share accounts 33. The view of a member share account from the perspective of a bill owner is provided in the GUI 157, which is shown in further detail in FIG. 11. Like any financial account, a summary view of the account balance is provided in section 161. The total balance is broken down into three parts, namely (1) pending balance represents funds that have not settled, (2) restricted balance represents funds tied to one or more virtual bill accounts, and (3) available balance represents settled funds that may be allocated by the sharing network for member sharing or withdrawn by the member. Transactions related to the member share account are detailed by transaction type and description in section 162, and the transaction amounts and running balance is detailed as well in section 163. The member share account also provides the member 36 with access to initiate certain account activities, here via a pull-down menu 165.

In the case of the bill owner, transactions 164 are displayed as a credit because they represent funds shared by the contributors to pay a medical bill of the bill owner's household. The $780.00 sharing transfer transaction 164 represents shared funds collected in virtual bill account #IHS-VB872098 for a household member of the network member (Anthony Meggs). However, all sharing transactions related to virtual bill account #IHS-VB872098 have NOT been completed as indicated by the “padlock” icon, thus making the $780.00 restricted funds, which cannot be accessed by the network member or transferred to the bill service provider. This feature of virtual bill accounts 46 helps provide greater transparency and engagement in the P2P sharing process, which is the ability to display the “aggregated sum” of sharing transactions as a single sharing transfer credit in the member share account of the bill owner when the receipts span many contributors over a period of time.

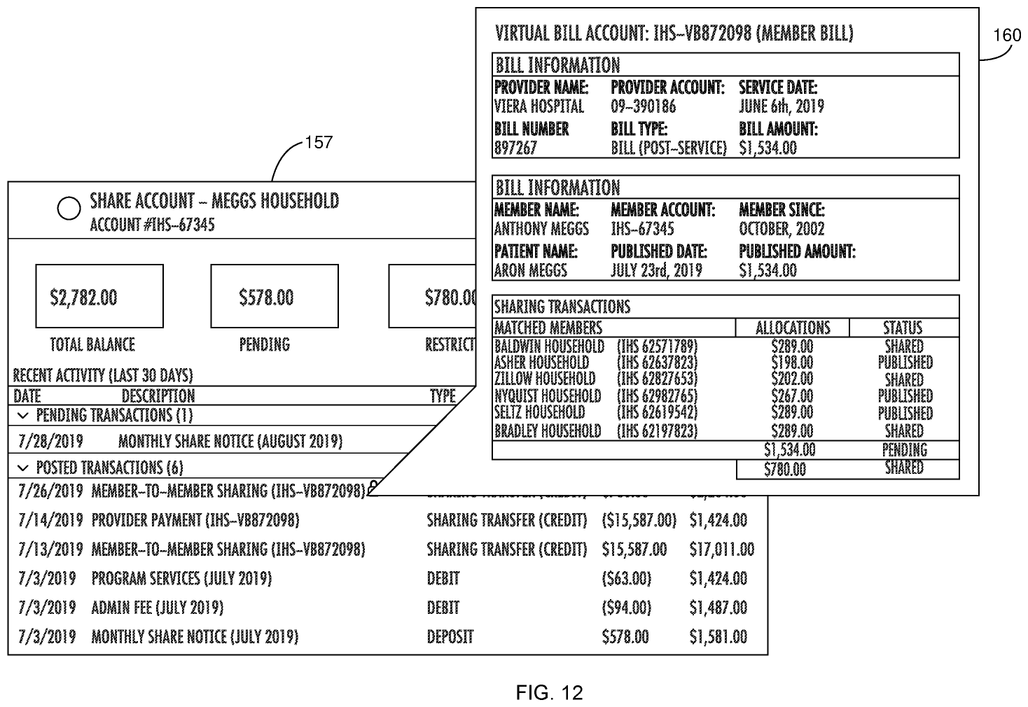

Another feature that helps improve transparency and engagement is the ability to easily view the many transactions and contributors behind the single sharing transfer credit transaction 164 in the member share account of the bill owner. As illustrated in FIG. 12, virtual bill accounts 46 enable sharing networks to deploy member share accounts that allow members to access P2P sharing details at the touch of a button. In the illustrated example, the $780.00 sharing credit is hyperlinked to a detailed pop-out GUI 160 view of the virtual bill account #IHS-VB872098. The detailed view provides the bill owner with an awareness as to who is contributing and sharing in the medical bills of the member's household. Moreover, in some configurations a social view may be provided (not shown) in which images of contributors are provided, along with information about them (location, etc.) and the ability to chat or send messages between them to engage in social interactions and communications that drive greater engagement and a social transparency into the P2P sharing process.

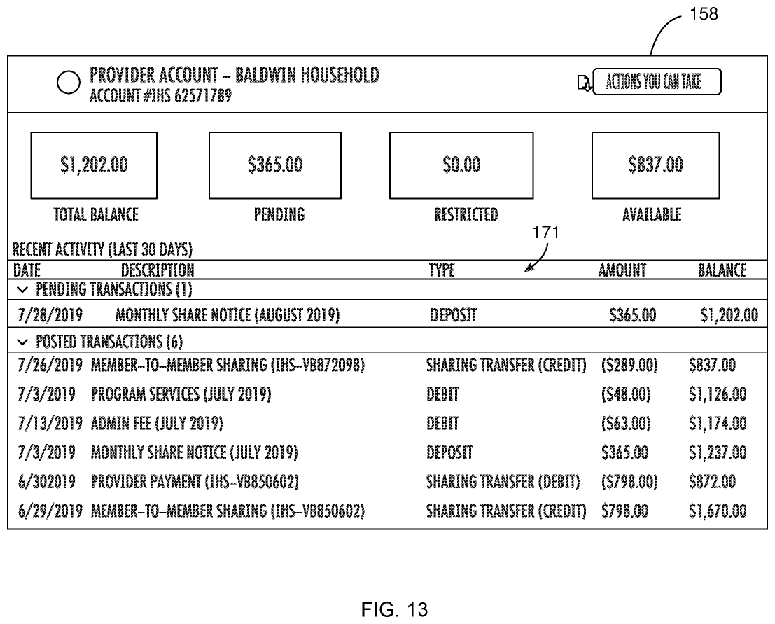

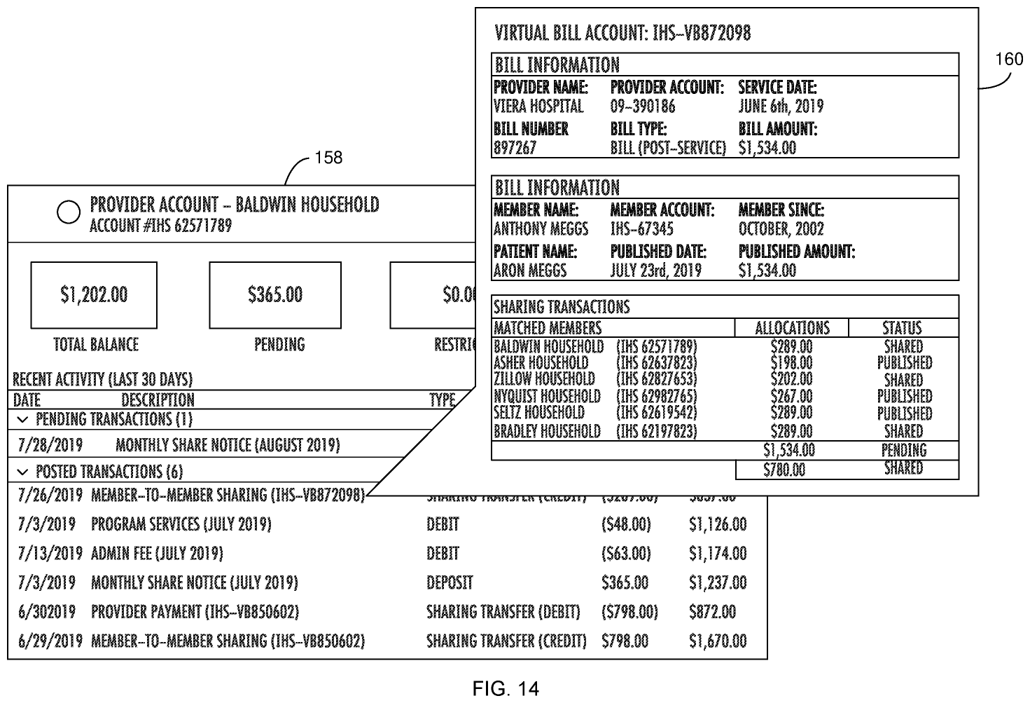

Still another feature that helps promote greater engagement and transparency is that the bill contributors benefit from the same enabling account linking capabilities associated with virtual bill accounts 46. In the case of healthcare sharing, members 36 are both bill owners and bill contributors, often at the same time. So, as illustrated in FIG. 13, member share accounts will also display sharing transactions, from a bill contributor point of view, as a single transaction. However, the transaction is registered as a debit, and that debit represents the actual allocated amount that the VSE module 37 has transferred from the bill contributor's share account 33 and settled in the virtual bill account 46. In the illustrated example, the $289.00 sharing transfer debit transaction 171 is the allocated amount that the Baldwin household has contributed to the Meggs household and settled in virtual bill account #IHS-VB872098. Just as a bill owner transaction, the bill contributor transaction is hyper-linked to the virtual bill account 46 so that the GUI 160 will be displayed as a pop-out window (FIG. 14) for easy access to the detailed sharing transactions of the member medical bill 38 (or pre-service request 41). Thus, network members 36 are given visibility into the members 36 that their contribution has helped, as well all other contributors to the member bill 38.

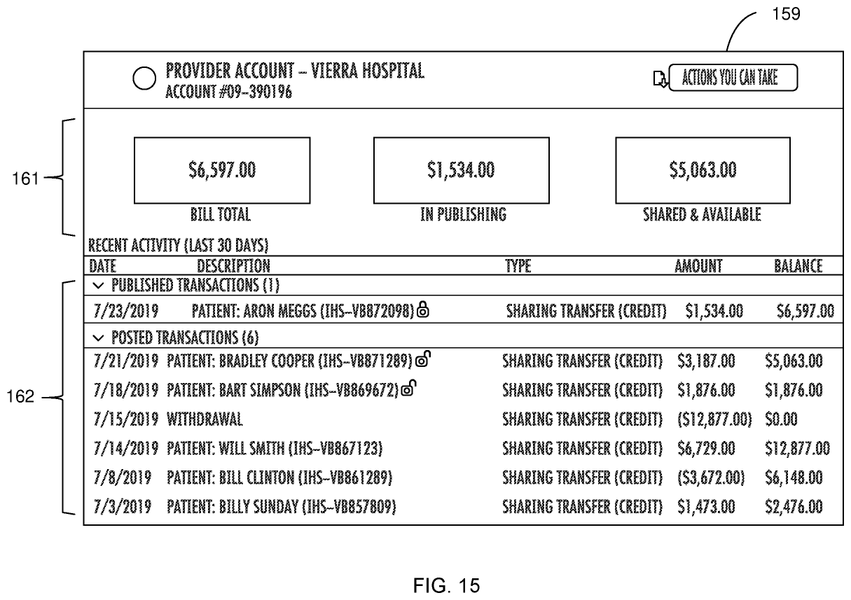

Lastly, the bill linking feature of virtual bill accounts enables Healthcare sharing networks to engage the medical provider into the sharing process that gives them access and transparency that they desire. Networks that invite Providers to open accounts on their VSE Platform, or join a payor service that integrates the VSEs of multiple sharing networks, will equip providers with a unique view into the P2P sharing process. Provider accounts, as illustrated in FIG. 15, can provide medical providers with a summary view into all their patient bills being processed by sharing networks (FIG. 15, Section 161). total bills represents the value of all “bill in publishing”, plus all “shared and available bills”. Bills in Publishing represents the total published amount of patient bills that are not yet fully shared. “Shared and available” represents patient bills that have been fully shared, but not yet withdrawn by the provider. A detailed transactional list of all patient bills is provided (FIG. 15, Section 162), as well as their published amounts and a running account balance. The provider account also provides access to initiate withdrawal of funds (payments) for patient bills that have been fully shared. Like member share accounts, the transactional list of patient bills provides a hyper-link to the detailed virtual bill account associated with each patient bill. Also, like the member share accounts, the detailed view of the virtual bill account provides the medical provider a view of all the bill contributors who shared in the payment of the patient's bills. This level of transparency engages medical providers into the sharing process and builds their confidence in healthcare sharing as a credible payment option.

Virtual bill accounts 46 also help enhance the security and protection of the P2P sharing process. In the case of healthcare sharing, networks members are happy to participate in a sharing process that is easy to manage, saves them money and is credible. In addition to the cost savings, another valued benefit cited by members 36 is the social satisfaction in knowing that their money is going directly to another member and not to the profits of an insurance company. The use of virtual bill accounts insures members 36 that their funds are going directly for the payment of another's member bill. As previously noted, though funds contributed to a member medical bill 38 are displayed in the share account of the bill owner as a sharing credit transaction 164, those funds are actually held in a separate virtual bill account 46 for the purpose of sharing and paying the bill owner's household bill. In fact, even though funds have been contributed to the bill owner for the payment of a bill, access to the funds have been restricted as noted in the restricted balance and may be indicated by a “padlock” icon appended to the sharing credit transaction 164. Thus, network members 36 have confidence in knowing that “shared funds” are NOT available to the bill owner for withdrawal. Network members are assured that the dollars they share for another member's medical bill 38 (or pre-service request 41) is certain to go to the medical provider as payment.

Likewise, in the provider account 44 displayed in the GUI 59 (FIG. 15), payment for patient bills 38 that have been published for sharing appear as a restricted credit amount. Published bills that have not yet been fully shared are placed in a “pending” status in the provider account 44 and are restricted as noted by the “padlock” icon. Also, like the bill owner view, the provider account 44 has not actually been credited the bill amount as this point. In reality, any settled contributions still reside in the virtual bill account. However, the account linking feature of virtual bill accounts 46 enables sharing networks to display published bills 38 (or pre-service requests 41) as a pending payment in the provider account. This gives the provider, as well as the contributors, a sense of confidence and security that a patient's bill 38 has been received and published for sharing, and that any contributed amounts are being collected in a virtual bill account 46 that has been created and linked to the provider for the purpose of paying the provider the published amount.

Furthermore, the security and protections provided by the VSE module 37 and the virtual bill accounts 46 accommodate the fact that sometimes the sharing network pre-pays or escrows funds for expensive procedures before services can be rendered (i.e., for pre-service escrow requests 41). In this case, sharing networks can allocate, publish and share the pre-service bill or quote 41 and hold collected funds in the virtual bill account 46 that was created for the procedure. By linking the virtual bill account 46 to the provider account 44, the pre-service bill 41 is seen as a “pending” credit transaction that is restricted. Thus, the provider has a sense of security that the bill has been funded and the network members are secure knowing that the dollars are not released from the virtual bill account 46 until the service has been rendered.

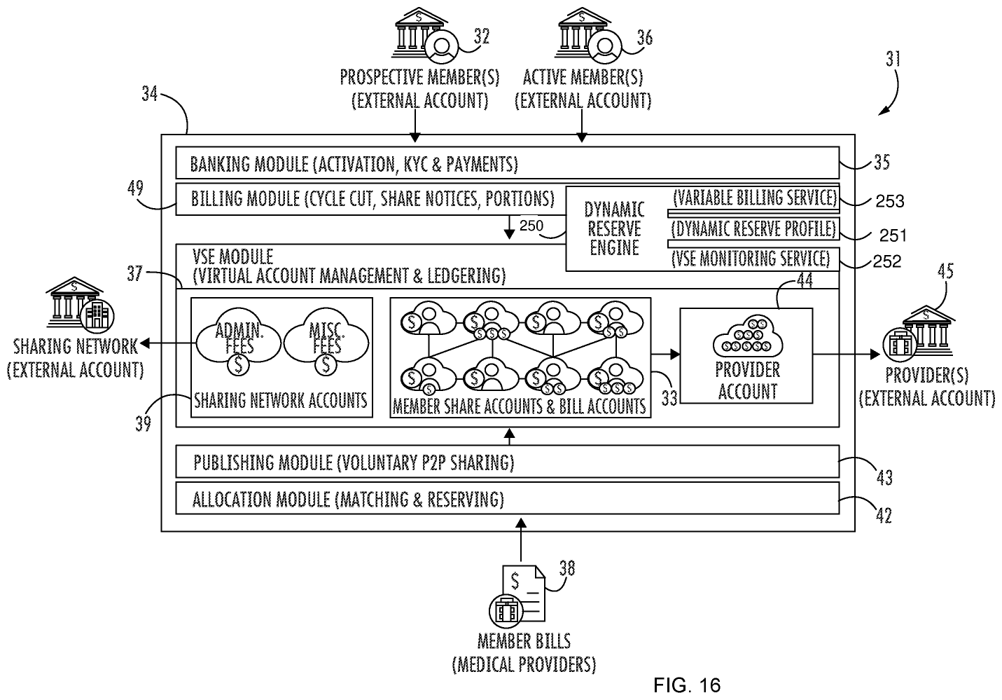

Turning now to FIG. 16, insurance companies across numerous industries build and retain financial reserves as part of their regulatory obligations. Reserves are required to pay large catastrophic bills, as well as to manage spikes in bill flows that are greater than the ordinary flow of claims. These companies are free to leverage a significant amount of their premium income and reserves into approved financial investments. However, none of the investment profits benefit the policyholders, rather it effectively serves as a free loan to the insurance company.

Even though sharing networks are unregulated, they also need to build, retain, and access reserves to maintain the fiscal health of the network. Like insurance, sharing networks can experience the same spikes in bill flow or be affected by large catastrophic bills. Thus, sharing networks are motivated to build and sustain targeted reserve levels. However, to avoid being deemed an unlawful insurance company, sharing networks do not take receipt of member funds and “pool” those funds to build reserves. To circumvent the risk of being deemed insurance, sharing networks, in the VSE computing platform 31, members 36 build and hold excess amounts in the share accounts 33 that they personally own. This is called distributed reserving or distributed reserves.

Sharing networks can build distributed reserves by pricing the member monthly share amounts higher than what is needed to share and pay the average monthly flows of bills. The distributed reserves build in the share accounts, but the sharing network never takes receipt of member funds. However, the network can access funds in the share accounts 33, per the sharing guidelines and the permissions given to the network by the members 36. Thus, the distributed reserves can be used to absorb catastrophic medical events and to pay member bills quickly.

Generally speaking, the VSE platform 31 of FIG. 16 is advantageously configured to automatically and dynamically facilitate sharing through share accounts 33 to targeted levels using dynamic reserves. Through enhancements and extensions of the VSE billing module 49, sharing networks can dynamically react to stresses and excesses of targeted reserved levels by engineering a variable bill amount (or dynamic reserve portion) to the monthly share amount (or portion) to sustain its distributed reserves. As reserves grow in excess of targeted levels, member accounts 33 are automatically credited by the VSE module 37. As reserves fall below targeted levels, member accounts 33 are debited a small amount by the VSE module 37. Incorporating a small variable amount in a monthly share notice helps a network regulate reserve targets, as well as deepens the loyalty of members 36 by helping to ensure them that the reserve amounts held in their share accounts 33 will not grow too large or too small.

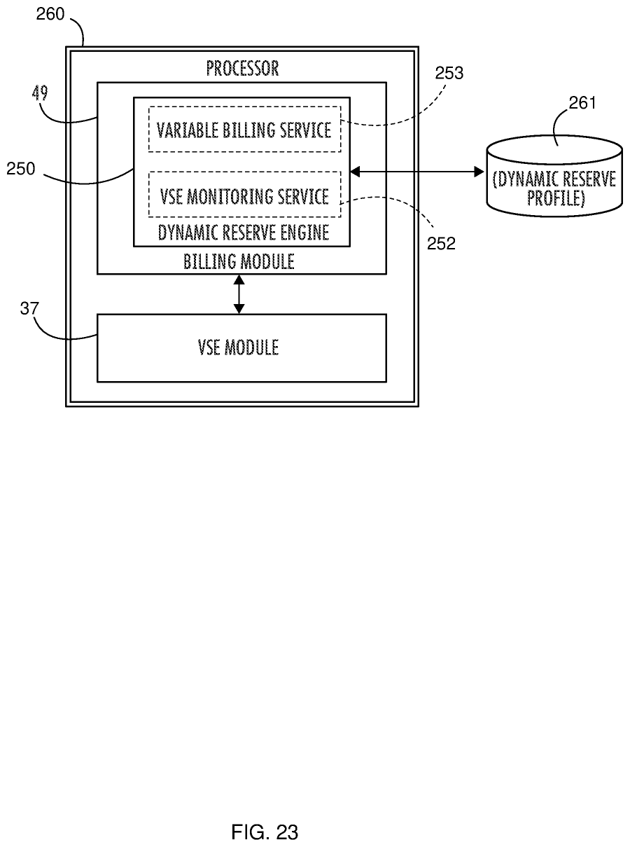

Referring additionally to FIG. 23, the computing system 30 and related methods allow sharing networks to regulate and sustain targeted reserve levels by dynamically allocating a variable amount to the monthly invoice/statements of its members 36. In the illustrated example, a dynamic reserving engine 250 may be implemented by a processor 260 and associated memory 261 within the billing module 49 of the server 34 to extend the capabilities of the VSE billing module 37. Sharing networks who utilize the VSE platform 31 with a dynamic reserving engine 250 may advantageously monitor key performance and leading indicators to assess and forecast near-term changes in reserve levels. Armed with the necessary intelligence to assess reserve levels, sharing networks may configure the dynamic reserving engine 250 to regulate their reserves through variable amounts that may be credited or debited in a monthly (or other time period) share notice published to members 36.

The dynamic reserving engine 250 extends the VSE platform 31 of a healthcare sharing network, in that it is configured to sustain targeted reserve levels by automatically calculating and allocating a variable amount to be assigned to the monthly share notice. The dynamic reserving engine 250 includes three separate components or services that are used to maintain reserve levels. The first is a dynamic reserve profile 251 (which may be implemented in a database stored in the memory 261), which may be configured to provide triggers and boundaries for billing the variable amount. The second component is a VSE monitoring service or module 252 configured to automatically track and monitor performance indicators used to assess and forecast near-term changes in reserve levels. The third component of the dynamic reserve engine 250 is a variable billing service or module 253, which is configured to automatically calculate and assign the amounts to be billed to the monthly share amount.

Upon initially configuring the virtual share exchange, a health care sharing network enables the dynamic reserving engine (DRE) 250. As previously noted, to enable the DRE 250 the sharing network first configures the dynamic reserve profile 251. The dynamic reserve profile 251 sets the boundaries or thresholds for automatically determining when to assign a variable amount to the share notice, as well as the amount to assign. While the dynamic reserve profile 251 can be configured with many attributes that can be used to trigger and calculate the share notice assignment, two example attributes may be particularly beneficial in the dynamic reserve profile.

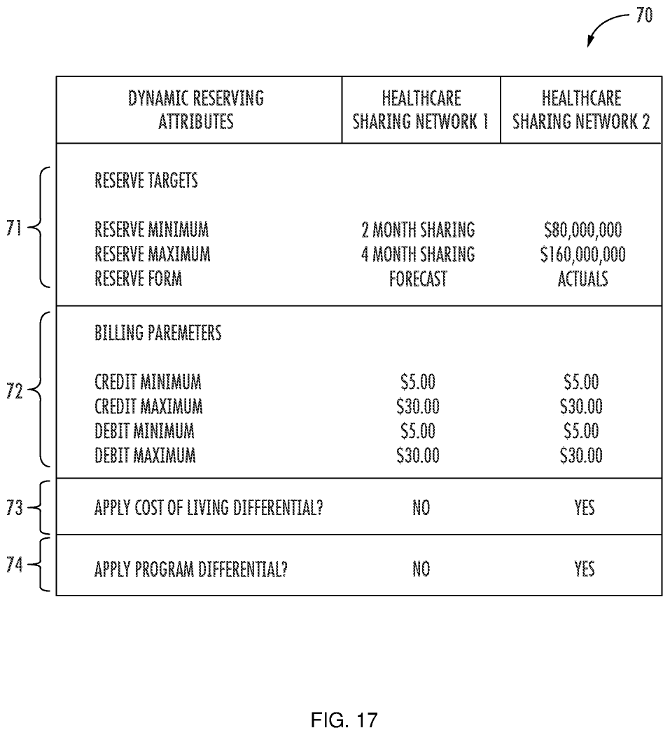

Referring additionally to the table 70 and sections 71-74 of FIG. 17, the first attribute is reserve targets 71 in the form of the “minimum” reserve amount and a “maximum” reserve amount. Reserve targets 71 enable the DRE 250 to know when, and when not, to bill a variable amount to member share notices. The “reserve minimum” provides the thresholds to initiate a debit to share notices, to increase distributed reserves, and replenish falling reserve levels. The “reserve maximum” provides the thresholds to initiate a credit to share notices and decrease distributed reserves. Decreasing the excess reserves and crediting share notices is a windfall to members 36 that builds loyalty and sets sharing networks apart from insurance companies. The reserve targets 71 also include the form or type of reserve trigger for the assignment of variable bill amounts. Thus, the reserve profile can be configured to use “actual” reserve amounts as the trigger for dynamic reserving, or it may be configured to use a “forecasted” amount as the DRE 250 trigger.

A second attribute of the dynamic reserve profile is billing parameters 72. Billing parameters also come in the form of “minimums and maximums”, but for the debit or credit amounts that are triggered by the dynamic reserving engine 250 and billed on monthly share notices. The maximum billing parameters 72 set the boundaries to the dynamic reserving engine 250 for how much of a debit amount or credit amount can be billed on the share notices. The maximums set an expectation in the minds of members of how much their share notice might increase or decrease in a given month, so they can plan accordingly. The minimum billing parameters 72 set a minimum amount that can be debited or credited, and may be used to help avoid trivializing the dynamic reserving process in the minds of members 36. There are other attributes that can be embedded in the dynamic reserve profile and used to calculate the variable amounts billed by the dynamic reserving engine. For instance, cost of living differentials 73 can be used to factor the actual variable amounts based on geographical living costs. Program differentials 74 may also be used to assign different variable amounts by program types.

An example of two dynamic reserve profiles for separate networks is provided in FIG. 17. Share network #1 has set its minimum and maximum reserve triggers in the form of a number of “sharing months”. Network #1 has set its reserve minimum at 2 months sharing and has set its reserve maximum at 4 months sharing. Network #2 has set its triggers in terms of nominal amounts; $80,000,000 as its reserve minimum and $160,000,000 as its reserve maximum. Network #1 intends to use “forecasted” reserves as its dynamic reserve trigger, whereas Network #2 will use “actual” reserves. Forecasted reserves may be desirable in some implementations as they enable a network to leverage key performance and leading financial indicators to proactively and automatically regulate reserves before the rise above or fall below targeted levels. Network #1 and Network #2 have set similar billing parameters. They both have set $5.00 as the minimum credit amount and debit amount that can be assigned as a variable bill amount. Both networks have also set $30.00 as the maximum debit amount that can be billed to share notices. Network #1 has chosen not to apply cost of living differentials or program differentials in the amounts it assigns to share notices. On the other hand, Network #2 intends to apply both.

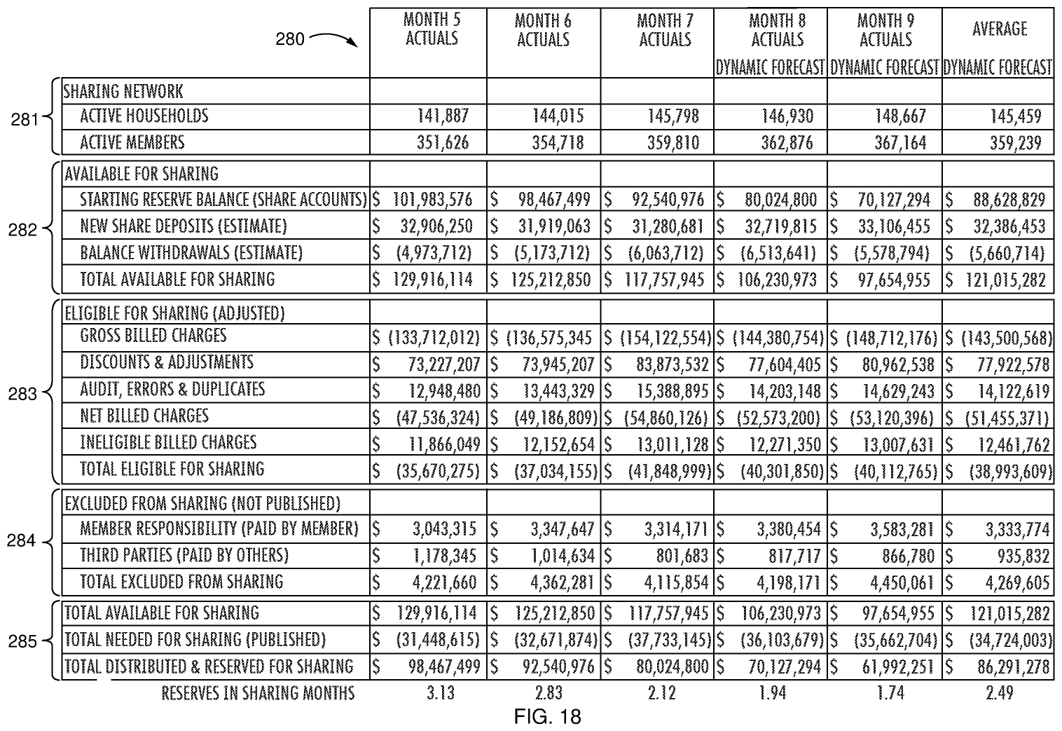

The VSE monitoring service 252 enables the DRE 250 to persistently monitor the sharing accounts of the sharing network and the performance metrics that are used to assess and forecast near-term changes in the distributed reserves. In addition to a persistent monitoring of specific performance metrics and leading indicators, the VSE monitoring service 252 generates periodic reserve summaries (see FIG. 17) that are fed into the variable billing service 253. Sharing networks that facilitate bill sharing through the VSE platform 31 are uniquely positioned to benefit from dynamic reserving because the VSE platform can equip a sharing network to generate reserve summaries that dynamically assess and forecast performance indicators that may be used to implement dynamic reserving, which are now discussed further with reference to the table 280 of FIG. 18 which illustratively includes sections 281-285.

To accurately assess and forecast near-term reserve levels, a sharing network may desire to estimate, monitor and track their total funds available for sharing (section 282) on a per month basis. Total funds available for sharing are derived from three different input sources. First, the starting available balance may be determined by assessing the reserve dollars that are held in member share accounts (i.e., distributed reserves) at the beginning of the month. Second, new share deposits may be estimated for the current month. New deposits come in the form of share notice payments, minus the admin fees that the network collects as operating expenses. Third, balance withdrawals are estimated over the defined time period to account for members who terminate their membership and withdraw available funds from their share accounts.

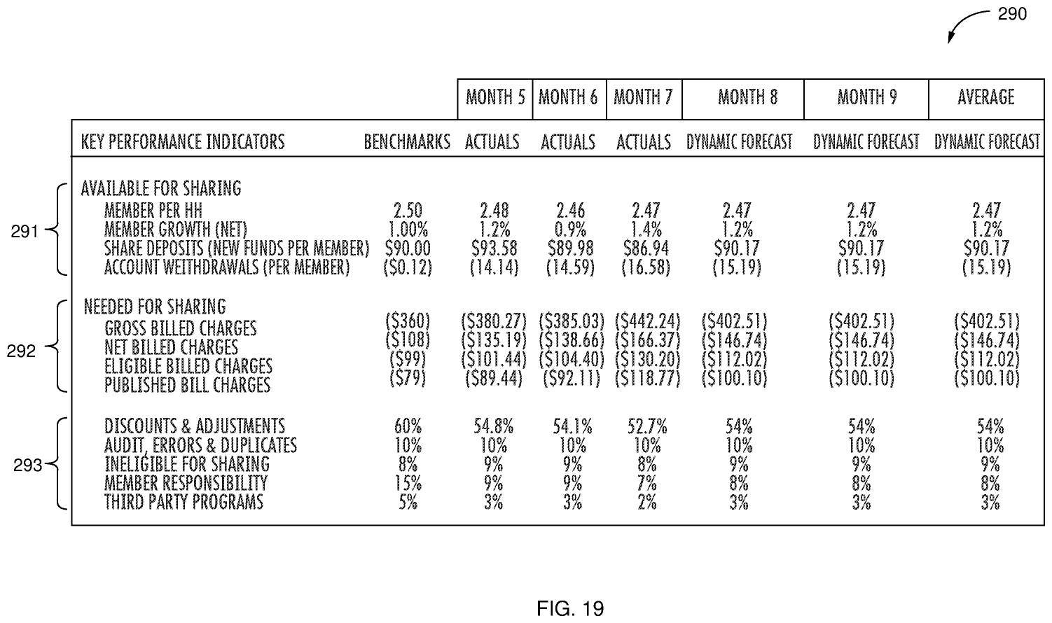

By adding the estimated new share deposits to the starting available reserve balance and then subtracting the estimated balance withdrawals, a sharing network can forecast its total funds available for sharing. Referring additionally to the table 290 and sections 291-293 of FIG. 19, while the VSE monitoring service 252 can track multiple key performance indicators (KPIs) and metrics for assessing and forecasting total funds available, the most used metrics (section 291) may be those that generate some manifestation of member growth (net new members), monthly share deposits (new funds per member) and account withdrawals (net withdrawn per member).

Once the DSE 250 estimates its total funds available for sharing, it next assesses and forecasts total funds needed for sharing (section 285). Funds needed for sharing represents the net dollars, in terms of member medical bills 38, that are to be published to the members for sharing during the time period. Funds needed for sharing are typically derived from two primary input sources. First, the DRE 250 calculates the total bill amounts that are eligible for sharing (section 283). This is the aggregate amount of medical bills received by the network that have been reduced by bill amounts that are ineligible for sharing and have been reduced by discounts and audit findings.

The second input source used to calculate funds needed for sharing is to assess and forecast amounts excluded from sharing (section 284). This represents bill amounts that are not published to the members for sharing, but are paid by others. Typically, these are member responsibility amounts paid by bill owners themselves, or amounts paid by third parties. By subtracting the “excluded from sharing” from the “eligible for sharing”, the network is able to derive the total funds needed for sharing.

The VSE monitoring service 252 may be configured to automatically track multiple KPIs and metrics for assessing and forecasting the total funds needed for sharing. However, the most used metrics (section 292) may be those that generate some manifestation of gross billed charges (per member), net bill charges (per member), eligible bill charges (per member) and published bill charges (per member). The VSE platform 31 may also track additional metrics (section 293) such as the bill discount or adjustment rate, audit and error rate, bill ineligible rill rate, member responsibility rate and third-party rate to better assess and forecast changes in the funds needed for sharing.

Armed with the ability to persistently monitor, track and assess the key performance indicators necessary to derive and forecast total funds available for sharing (section 281) and total funds needed for sharing (section 285), the DRE 250 is equipped to late and forecast total funds distributed and reserved for sharing (section 285). Funds distributed and reserved for sharing are those funds that remain in the member share accounts after the funds needed for sharing are subtracted from the available funds for sharing. These are the ending reserves that are available at the end of the month and can be used during the next sharing period. It is these ending funds, the total funds distributed and reserved for sharing that the dynamic reserving engine uses to trigger and assign a variable bill amount to the monthly share notice.

As previously noted, in addition to the persistent monitoring of key performance and leading indicators, the VSE monitoring service 252 generates periodic reserve summaries (FIG. 18) that are fed into the variable billing service 253. As also previously noted, the reserve summary assesses and forecasts the total funds distributed and reserved for sharing, which is used by the variable billing service 253 to determine if any amounts are assigned to the next monthly share notice. For example, in FIG. 17, Sharing Network #1 has set its reserve targets (section 71) in terms of sharing months to a maximum of four months and a minimum of two months. Network #1 has also chosen to use “forecasted reserves” as its reserve form and trigger. So, if forecasted reserves were to fall below the threshold of two months, then the dynamic reserving engine 250 would trigger a variable amount (a dynamic portion) to be billed on the next monthly share notice.

The reserve summary example in FIG. 18 illustrates a sharing network that has recently completed its seventh month of sharing. The most recent three months of “actual” performance metrics incorporated in the VSE monitoring service 252 have been tracked, monitored, assessed and recorded in the reserve summary. The next two months have been “dynamically forecasted” by the network's actual performance of the most recent three months, as noted in FIG. 18. This illustrates a significant feature and benefit of the dynamic reserving engine 250 and the VSE platform 31. The persistent and automated monitoring, assessment and forecasting of reserve values enables the network to be more proactive in sustaining reserve levels.

As a further example, in FIG. 18 the actual funds distributed and reserved for sharing (section 285) have fallen to $80,024,800 in Month 7 (the most recent month), and the amount for the 8th Month (the current month) is forecasted to fall to $70,127,294. Per the minimum reserve targets in FIG. 17, the variable billing trigger has been activated for Network #1 because the forecasted reserve amount has fallen below two months. However, the variable billing trigger has not been activated for Network #2 because the actual reserve amount has NOT yet fallen below $80,000,000. Therefore, in the case of Network #1, the reserve summary fed into the variable billing service or engine 253 will initiate a variable bill amount to be assigned to the monthly share notice.

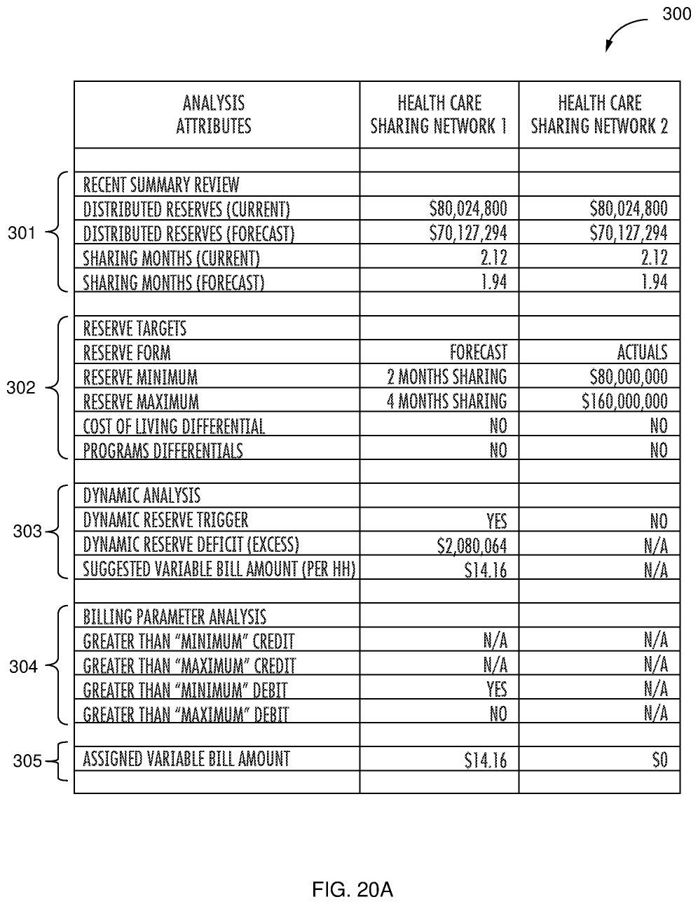

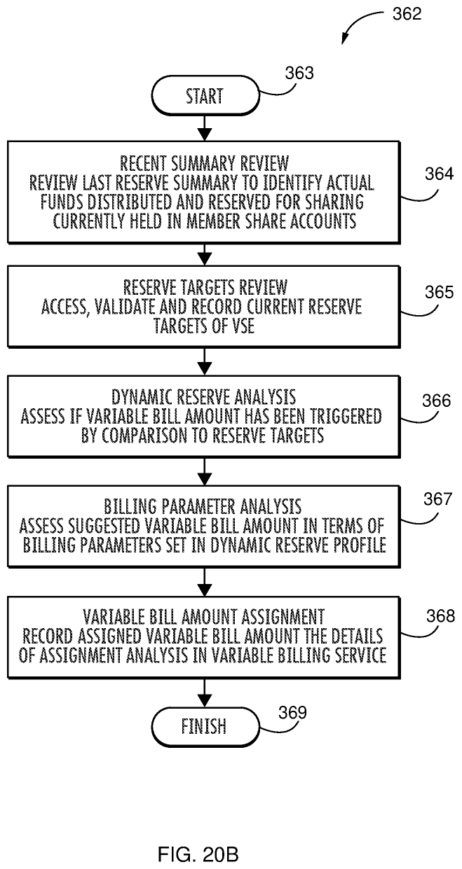

The third component of the dynamic reserving engine 50 is the variable billing service 253. The purpose of the variable billing service 253 is to analyze the results of the reserve summaries provided by the VSE monitoring service 252, and assess the financial health of the network's reserves. As illustrated in FIG. 4, the variable billing service 253 will execute an “assignment analysis” for each summary report. To complete the task, the variable billing analysis undertakes the following steps which are now described with reference to the table 300 of FIG. 20A and accompanying flow diagram 362 of FIG. 20B.

Beginning at Block 363, a first illustrated step is a recent summary review (section 301, Block 364). The variable billing service 253 views the last reserve summary to identify the actual funds distributed and reserved for sharing currently held in the member share accounts, as well as the near term forecasted funds. The reserved funds are reviewed in terms of nominal amounts and months of sharing. In FIG. 20A, the assignment analysis example illustrates that for Month 7 (the most recently completed month) the nominal value of the actual funds distributed and reserved for sharing is $80,024,800, and the forecasted reserves are expected to fall to $70,127,294 in Month 8. In terms of sharing months, the actual value of the reserves at the end of Month 7 is 2.12 sharing months, and the forecasted value for the following month (Month 8) is 1.94 sharing months.

The next step in the illustrated example is a reserve targets review (section 302, Block 365). More particularly, the assignment analysis accesses, validates and records the current reserve targets of the sharing network. In the case of Network #1, reserves are to be measured in the form of forecasted funds distributed and reserved for sharing. The “maximum” reserve target has been set at (4) sharing months and the “minimum” reserve target has been set at (2) sharing months. In the case of Network #2, reserves are to be measured in the form of “actual” funds distributed and reserved for sharing. The “maximum” reserve target has been set at a nominal value of $160,000,000, and the “minimum” reserve target has been set at $80,000,000.

A further step is the dynamic reserve analysis (section 303, Block 366). The variable billing service 253 assesses if a variable bill amount has been triggered by comparing the network's reserve targets to the actual funds distributed and reserved for sharing (Month 7) and the forecasted funds distributed and reserved for sharing” (Month 8). If a variable bill has been triggered, then the dynamic reserve deficit (or excess) is calculated. The dynamic reserve deficit (or excess) is calculated by subtracting the actual and forecasted reserve amounts from the reserve targets. If the result is greater than “$0”, then a debit may be assigned to the monthly share notice. If the result is less than “$0”, then a credit may be assigned to the monthly share notice. To calculate the debit or credit amount to be assigned to the monthly share notice, the reserve deficit (or excess) may be divided by the number of active households (section 281).

In the case of Network #1, the assignment analysis indicates that the dynamic reserve trigger has been activated because the “forecasted” share months has fallen below two months. The dynamic reserve deficit (or excess) has been calculated to be $2,080,064, which suggests that a debit of $14.16 would need to be assigned to the monthly share notice of every active household. In the case of Network #2, the assignment analysis indicates that the dynamic reserve trigger has not been activated because the “actual” funds distributed & reserved for sharing have not fallen below $80,000,000 or exceeded $160,000,000. Thus, there is no deficit or excess to be evaluated.

The next step in the illustrated example is a billing parameter analysis (section 304, Block 367). As a part of the assignment analysis, the variable billing service 253 assesses the suggested variable bill amount in terms of the billing parameters set in the dynamic reserve profile. If the “suggested” variable bill amount is a debit and it exceeds the “maximum” debit amount, then the variable billing service 253 may assign the maximum debit and not the “suggested” amount. If the “suggested” variable bill amount is a debit and it is below the “minimum” debit amount, then the variable billing service 53 should not assign the “suggested” amount. If the “suggested” variable bill amount is a credit and it exceeds the “maximum” credit amount, then the variable billing service 253 may assign the maximum credit and not the “suggested” amount. If the “suggested” variable bill amount is a credit and it is below the “minimum” credit amount, then the variable billing service 253 should not assign the “suggested” amount.

In the case of Network #1, the assignment analysis has indicated that the suggested variable amount of $14.16 is greater than the “minimum” debit amount and is less than the “maximum” debit amount. Thus, the suggested variable bill amount is the correct and allowable amount to be assigned to monthly share notice. In the case of Network #2, the assignment analysis has indicated that the suggested variable amount does not apply, because the dynamic reserve trigger was not activated.

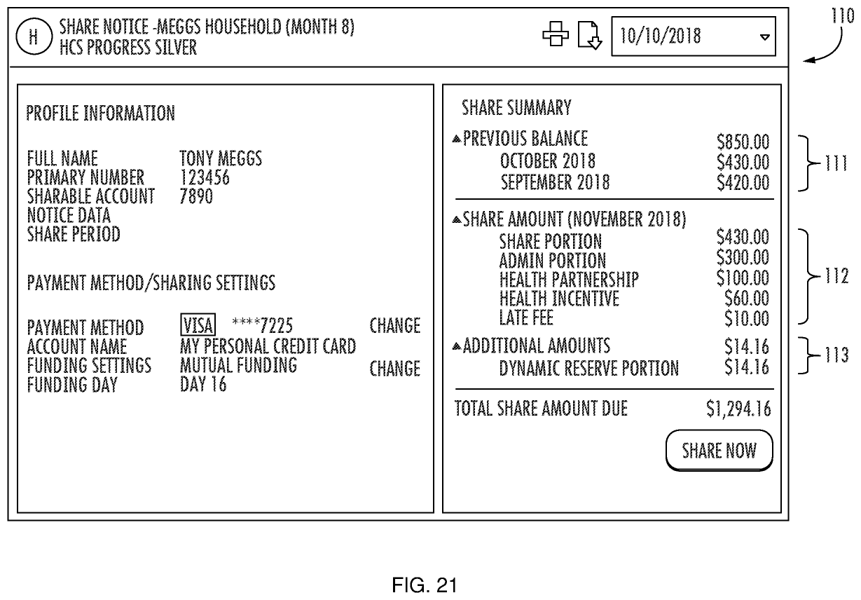

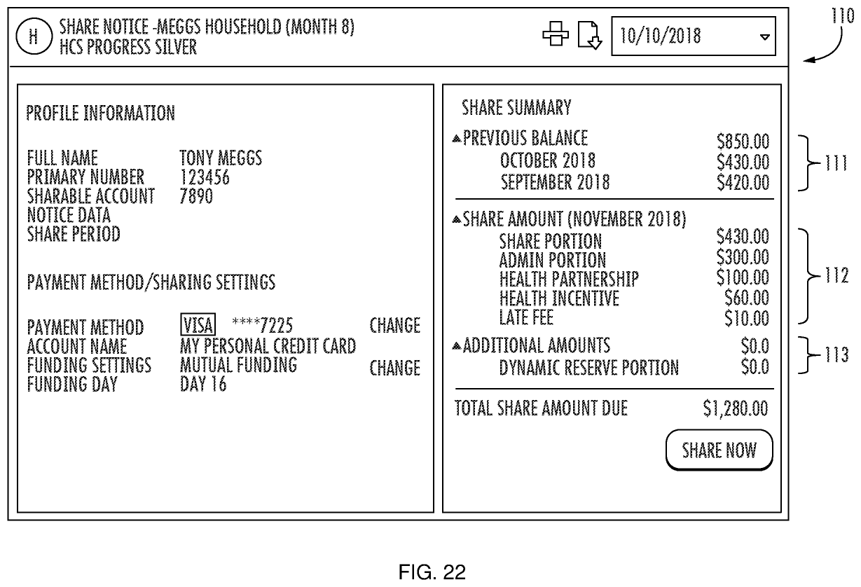

An assigned variable bill amount is the next step of the illustrated assignment analysis (section 305, Block 368), which is to record the assigned variable bill amount and the details of the assignment analysis in the variable billing service 253. The variable billing service 253 then submits the variable bill amount to the variable billing service 253 for billing. The assigned variable bill amount is passed into the variable billing service 253 and recorded in the share notice file for the next share period. On the day of the monthly cycle cut the assigned variable bill amount is published to the monthly share notice (FIG. 21 or 22) and collected during the normal payment process. Thus, the sharing network is enabled to replenish its distributed reserves. The method of FIG. 20B illustratively concludes at Block 369.

In the case of Network #1, the assignment analysis assigned a $14.16 debit amount to be billed to the monthly share notice. Per the example in graphical user interface 110 shown in FIG. 21, the VSE billing service 253 has added $14.16 to the monthly share notice and is titled as the dynamic reserve portion (section 113). The $14.16 is included in the additional amounts, which are amounts added to total share amount due. The total share amount due is the sum of any previous balances (section 111), the monthly share amount for the current month (section 112) and the additional amounts (section 113). By adding the $14.16 debit to the share notice of every active household, the network is replenishing its reserves with approximately $2,080,528. This process can be repeated again the following month if reserve levels continue to fall below the thresholds.

In the case of Network #2 (FIG. 7), the assignment analysis has assigned $0.00 to the monthly share notice. The assignment is $0.00 because “actual” distributed reserves have not yet fallen below $80,000,000. The variable billing service 253 generates and publishes share notices for every active household and the dynamic reserve portion is billed at $0.00 (section 113 in FIG. 22).

The above-described VSE platform 31 advantageously provides a computing infrastructure that provides a dynamic reserving engine 250 equipped to automatically regulate distributed reserves and ensure that reserve levels are sustained to their targeted levels or thresholds. Networks utilizing the dynamic reserve engine 250 are better enabled to compete with the fiscal soundness of insurance, while growing the loyalty of members who are assured that reserves are managed to the appropriate levels.

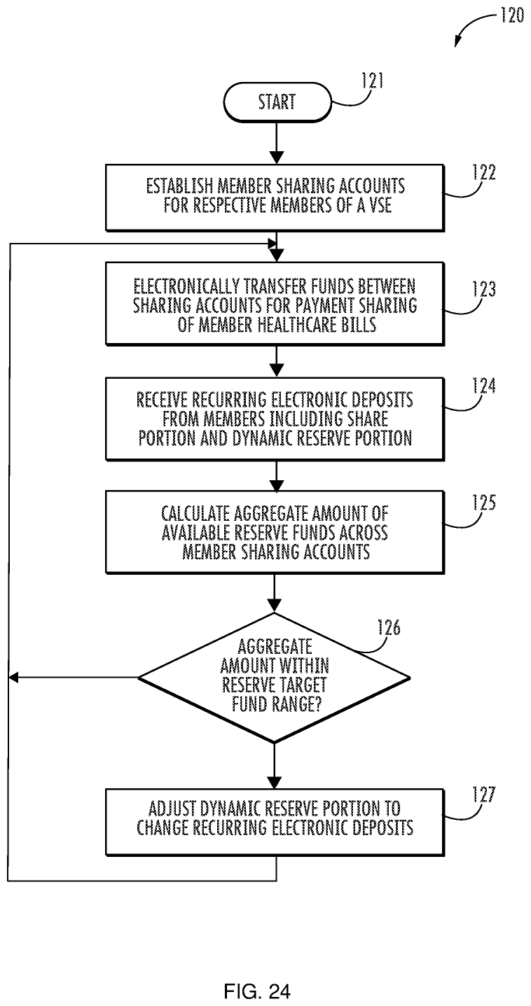

A related method is now described with reference to the flow diagram 120 of FIG. 24. Beginning at Block 121, the method illustratively includes operating the VSE module 37 for establishing member sharing accounts 33 for respective members 36 of a VSE for sharing payment of member healthcare bills across the member sharing accounts, at Block 121, and electronically transferring funds from or between the sharing accounts for payment sharing of the member healthcare bills, at Block 122. In some embodiments, virtual bill accounts may be used for payment sharing, as discussed further in co-pending application Ser. No. 15/931,767. The method further illustratively includes operating the billing module 49 and associated DRE 250 for receiving recurring electronic deposits from the members to fund the member sharing accounts, at Block 123, where the recurring electronic deposits include a share portion and a dynamic reserve portion to accumulate reserve funds in the member sharing accounts. The DRE 250 is also for calculating an aggregate amount of available reserve funds across the member sharing accounts as funds are electronically transferred for payment sharing of the member healthcare bills (Block 124), comparing the calculated aggregate amount of available reserve funds to a reserve target fund range (Block 125), and adjusting the dynamic reserve portion to change the recurring electronic deposits responsive to the calculated aggregate amount of reserve balance falling outside of the reserve balance target range to bring the aggregate amount of reserve balance funds back into the reserve balance target range (Block 127), as discussed further above. The method of FIG. 24 illustratively concludes at Block 128.

Further details regarding example VSE platform 31 implementations are provided in co-pending application Ser. No. 16/881,528 (filed May 22, 2020); Ser. No. 15/931,767 (filed May 14, 2020); Ser. No. 15/931,786 (filed May 14, 2020); and 16/876,736 (filed May 18, 2020), all of which are hereby incorporated herein in their entireties by reference.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A computing device comprising:
a memory and a processor configured to cooperate with the memory to operate a virtual share exchange (VSE) platform by
establishing member sharing accounts on the VSE platform for respective members of the VSE platform for receiving recurring electronic deposits from the respective members from external payment sources to be used for sharing payment of member healthcare bills across a plurality of the member sharing accounts, the member sharing accounts having unique identifiers (IDs), and the recurring electronic deposits including a share portion and a dynamic reserve portion to respectively accumulate sharing funds and reserve funds in the member sharing accounts,
establishing healthcare provider accounts on the VSE platform for healthcare providers issuing member healthcare bills,
receiving a given member healthcare bill issued by a given healthcare provider,
matching and allocating payment amounts of the given member healthcare bill to sharing funds in member sharing accounts on a member-to-member basis based upon member agreement to share in payment of the given member healthcare bill,
dynamically generating in real time a single purpose table in a database on the VSE platform for the given member healthcare bill submitted for payment sharing corresponding to the given healthcare provider, the single purpose table defining a temporary virtual bill account solely for reconciliation of the respective member healthcare bill, the temporary virtual bill account being externally addressable through a routing number and a unique account number,
the single purpose table linking the given member healthcare bill to the unique IDs of the member sharing accounts of members sharing in the given member healthcare bill so that transactions in the temporary virtual bill account are viewable to members sharing in the given member healthcare bill,
electronically transferring sharing funds from the member sharing accounts to the healthcare provider account for the given healthcare provider that issued the given member healthcare bill using the externally addressable routing number and unique account number of the temporary virtual bill account based upon the single purpose table and without transferring the funds between the member sharing accounts, and
closing and archiving the virtual bill account upon electronically transferring the funds to the healthcare provider account for the given healthcare provider that issued the member healthcare bill, the archived virtual bill account providing an auditable ledger for the transactions in the temporary virtual bill account.

2. The computing device of claim 1 wherein the processor is further configured to:
calculate an aggregate amount of available reserve funds across the member sharing accounts as funds are electronically transferred for payment sharing of the member healthcare bills;
compare the calculated aggregate amount of available reserve funds to a reserve target fund range, and
adjust the dynamic reserve portion to change the recurring electronic deposits responsive to the calculated aggregate amount of reserve balance falling outside of the reserve balance target range to bring the aggregate amount of reserve balance funds back into the reserve balance target range.

3. The computing system of claim 2 wherein the reserve target fund range comprises a real-time minimum aggregate amount of available reserve funds, and a real-time maximum aggregate amount of available reserve funds.

4. The computing system of claim 2 wherein the reserve target fund range comprises a forecasted minimum aggregate amount of available reserve funds, and a forecasted maximum aggregate amount of available reserve funds.

5. The computing system of claim 4 wherein the forecasted minimum and maximum aggregate amounts of available reserve funds are based upon at least one of a number of net new members to the VSE, an aggregate amount of new funds per member, and net withdrawals per member, over a time period.

6. The computing system of claim 2 wherein adjusting comprises changing the dynamic reserve portion of the electronic deposits further based upon a cost of living differential associated with respective different geographical locations of the members of the VSE.

7. The computing device of claim 1 wherein the processor is further configured to generate graphical user interfaces (GUIs) for viewing the transactions in the temporary virtual bill account.

8. The computing device of claim 1 wherein the processor is further configured to receive pre-payment requests issued by the healthcare providers for funding prior to performing healthcare services, and configured to dynamically generate in real time single purpose tables defining temporary virtual bill accounts for payment sharing for the pre-payment requests.

9. A method comprising:
at a computing device, operating a virtual share exchange (VSE) platform by
establishing member sharing accounts on the VSE platform for respective members of the VSE platform for receiving recurring electronic deposits from the respective members from external payment sources to be used for sharing payment of member healthcare bills across a plurality of the member sharing accounts, the member sharing accounts having unique identifiers (IDs), and the recurring electronic deposits including a share portion and a dynamic reserve portion to respectively accumulate sharing funds and reserve funds in the member sharing accounts,
establishing healthcare provider accounts on the VSE platform for healthcare providers issuing member healthcare bills,
receiving a given member healthcare bill issued by a given healthcare provider,
matching and allocating payment amounts of the given member healthcare bill to sharing funds in member sharing accounts on a member-to-member basis based upon member agreement to share in payment of the given member healthcare bill,
dynamically generating in real time a single purpose table in a database on the VSE platform for the given member healthcare bill submitted for payment sharing corresponding to the given healthcare provider, the single purpose table defining a temporary virtual bill account solely for reconciliation of the respective member healthcare bill, the temporary virtual bill account being externally addressable through a routing number and a unique account number,
the single purpose table linking the given member healthcare bill to the unique IDs of the member sharing accounts of members sharing in the given member healthcare bill so that transactions in the temporary virtual bill account are viewable to members sharing in the given member healthcare bill,
electronically transferring sharing funds from the member sharing accounts to the healthcare provider account for the given healthcare provider that issued the given member healthcare bill using the externally addressable routing number and unique account number of the temporary virtual bill account based upon the single purpose table and without transferring the funds between the member sharing accounts, and
closing and archiving the virtual bill account upon electronically transferring the funds to the healthcare provider account for the given healthcare provider that issued the member healthcare bill, the archived virtual bill account providing an auditable ledger for the transactions in the temporary virtual bill account.

10. The method of claim 9 further comprising, at the computing device:
calculating an aggregate amount of available reserve funds across the member sharing accounts as funds are electronically transferred for payment sharing of the member healthcare bills;
comparing the calculated aggregate amount of available reserve funds to a reserve target fund range; and
adjusting the dynamic reserve portion to change the recurring electronic deposits responsive to the calculated aggregate amount of reserve balance falling outside of the reserve balance target range to bring the aggregate amount of reserve balance funds back into the reserve balance target range.

11. The method of claim 10 wherein the reserve target fund range comprises a real-time minimum aggregate amount of available reserve funds, and a real-time maximum aggregate amount of available reserve funds.

12. The method of claim 10 wherein the reserve target fund range comprises a forecasted minimum aggregate amount of available reserve funds, and a forecasted maximum aggregate amount of available reserve funds.

13. The method of claim 12 wherein the forecasted minimum and maximum aggregate amounts of available reserve funds are based upon at least one of a number of net new members to the VSE, an aggregate amount of new funds per member, and net withdrawals per member, over a time period.

14. The method of claim 10 wherein adjusting comprises changing the dynamic reserve portion of the electronic deposits further based upon a cost of living differential associated with respective different geographical locations of the members of the VSE.

15. A non-transitory computer-readable medium having computer-executable instructions for causing a computing device to perform steps comprising:
operating a virtual share exchange (VSE) platform by
establishing member sharing accounts on the VSE platform for respective members of the VSE platform for receiving recurring electronic deposits from the respective members from external payment sources to be used for sharing payment of member healthcare bills across a plurality of the member sharing accounts, the member sharing accounts having unique identifiers (IDs), and the recurring electronic deposits including a share portion and a dynamic reserve portion to respectively accumulate sharing funds and reserve funds in the member sharing accounts,
establishing healthcare provider accounts on the VSE platform for healthcare providers issuing member healthcare bills,
receiving a given member healthcare bill issued by a given healthcare provider,
matching and allocating payment amounts of the given member healthcare bill to sharing funds in member sharing accounts on a member-to-member basis based upon member agreement to share in payment of the given member healthcare bill,
dynamically generating in real time a single purpose table in a database on the VSE platform for the given member healthcare bill submitted for payment sharing corresponding to the given healthcare provider, the single purpose table defining a temporary virtual bill account solely for reconciliation of the respective member healthcare bill, the temporary virtual bill account being externally addressable through a routing number and a unique account number,
the single purpose table linking the given member healthcare bill to the unique IDs of the member sharing accounts of members sharing in the given member healthcare bill so that transactions in the temporary virtual bill account are viewable to members sharing in the given member healthcare bill,
electronically transferring sharing funds from the member sharing accounts to the healthcare provider account for the given healthcare provider that issued the given member healthcare bill using the externally addressable routing number and unique account number of the temporary virtual bill account based upon the single purpose table and without transferring the funds between the member sharing accounts, and
closing and archiving the virtual bill account upon electronically transferring the funds to the healthcare provider account for the given healthcare provider that issued the member healthcare bill, the archived virtual bill account providing an auditable ledger for the transactions in the temporary virtual bill account.

16. The non-transitory computer-readable medium of claim 15 further comprising, at the computing device:
calculating an aggregate amount of available reserve funds across the member sharing accounts as funds are electronically transferred for payment sharing of the member healthcare bills;
comparing the calculated aggregate amount of available reserve funds to a reserve target fund range; and
adjusting the dynamic reserve portion to change the recurring electronic deposits responsive to the calculated aggregate amount of reserve balance falling outside of the reserve balance target range to bring the aggregate amount of reserve balance funds back into the reserve balance target range.

17. The non-transitory computer-readable medium of claim 16 wherein the reserve target fund range comprises a real-time minimum aggregate amount of available reserve funds, and a real-time maximum aggregate amount of available reserve funds.

18. The non-transitory computer-readable medium of claim 16 wherein the reserve target fund range comprises a forecasted minimum aggregate amount of available reserve funds, and a forecasted maximum aggregate amount of available reserve funds.

19. The non-transitory computer-readable medium of claim 18 wherein the forecasted minimum and maximum aggregate amounts of available reserve funds are based upon at least one of a number of net new members to the VSE, an aggregate amount of new funds per member, and net withdrawals per member, over a time period.

20. The non-transitory computer-readable medium of claim 16 wherein adjusting comprises changing the dynamic reserve portion of the electronic deposits further based upon a cost of living differential associated with respective different geographical locations of the members of the VSE.
